(19) United States
(12) Patent Application Publication
(10) Pub. No.: US 2026/0265065 A1
(43) Pub. Date: Sep. 10, 2026

(54) Formulation of Graphene Networks from Carbon Nanotubes by Laser Shockwave Compaction

(71) Applicant: Northeastern University, Boston, MA (US)

(72) Inventors: Yung Joon JUNG, Boston, MA (US); Jianlin LI, Medford, MA (US); Juyeon SEO, Boston, MA (US); Ahmed BUSNAINA, Needham, MA (US)

(21) Appl. No.: 19/561,458

(22) Filed: Mar. 9, 2026

Related U.S. Application Data
(60) Provisional application No. 63/768,871, filed on Mar. 7, 2025.

(51) Int. Cl. C01B 32/19; B32B 9/04

(52) U.S. Cl. CPC C01B 32/19; B32B 9/04; C01B 2204/06; C01B 2204/22; C01B 2204/32; C01P 2002/78; C01P 2002/82; C01P 2002/85; C01P 2004/03; C01P 2004/04; C01P 2004/17; C01P 2006/12; C01P 2006/40

(57) ABSTRACT

A scalable, low-temperature, and rapid method to transform single walled carbon nanotubes (SWCNTs) into graphene structures, including SWCNT-graphene junctions and hybrid structures, is provided. The method uses high-rate, repetitive laser shockwave compaction, to compact and structurally alter the SWCNT and transform them into multilayered graphene structures. The method can be used for nanoscale to macroscale fabrication of electronic devices, thermal management devices, and to provide electrically and thermally conductive coatings.

### CROSS REFERENCE TO RELATED APPLICATIONS

This application claims the priority of U.S. Provisional Application No. 63/768,871 filed 7 Mar. 2025 and entitled “Formation of Graphene Networks from Carbon Nanotubes by Laser Shockwave Compaction”, the whole of which is hereby incorporated by reference.

### STATEMENT REGARDING FEDERALLY SPONSORED RESEARCH OR DEVELOPMENT

This invention was made with government support under Grant Number W911NF-21-2-0208 awarded by the U.S. Army Research Laboratory. The Government has certain rights in the invention.

### BACKGROUND

Carbon nanotubes (CNTs) have been considered as the ultimate building block for advanced applications ranging from electronic devices [1-4], reinforcement for composites [5-7], and ultrahigh-performance fibers[8,9] to energy storage devices [10,11] due to their exceptional mechanical strength with unique electrical properties and high thermal conductivity [1,12-14]. However, due to the van der Waals force induced weak interactions and ‘unconnected’ junctions between CNTs, these outstanding properties are still several orders of magnitude lower than theoretical properties in network architecture.

Extensive studies on structural transformation of CNTs or inter-tubular bonding modifications have been conducted over the past two decades to push the limits of their extraordinary properties [15-27]. It is well-established that single-walled carbon nanotubes (SWCNTs) can be effectively transformed into graphene nanoribbons (GNRs) by unzipping of tubular structure, such as chemical oxidation [15,16], metal-catalyzed cutting [18], and surface-catalyzed unzipping [19]. However, it typically requires harsh chemicals and complex processing steps, which makes it challenging to achieve effective and scalable synthesis. In addition to the unzipping of SWCNTs, the structural modification of SWCNTs can also be achieved through tube-tube coalescence. It has been reported that SWCNTs can be coalesced into multi-walled carbon nanotubes (MWCNTs) and GNRs [20,21] or graphitic fibers [22] at extremely high temperatures (1600-2700° C.), which are unlikely to be scalable for high-rate and energy-efficient manufacturing. Furthermore, structural tailoring of carbon atomic networks was conducted via plasma sintering^{[23]} and electron [24,25] and ion [26] beam irradiation. However, these methods are limited by the requirements of precise controls and low fabrication yield.

The drive to fully realize the superior intrinsic properties of carbon nanotubes (CNTs) in a broad range applications has been hindered by the existence of weak tube-tube interactions and ‘unconnected’ junctions in the architecture of CNT networks. Despite extensive studies on reconstructing the inter-tubular bonding of CNTs, effective and scalable fabrications are still limited due to the requirements of harsh conditions, high temperatures, and complex procedures.

### SUMMARY

The present technology provides a scalable, low-temperature method to transform single walled carbon nanotubes (SWCNTs) into graphene structures and networks of graphene structures, including SWCNT-graphene junctions and hybrid structures. Such structures enable advanced applications in electronics, thermal management, and energy storage, for example. The technology surpasses traditional methods such as high-temperature coalescence, chemical vapor deposition, and catalyzed unzipping, which rely on harsh chemicals, high temperatures, and complex procedures. The present technology thus offers a more efficient and sustainable alternative process for making advanced graphene structures.

The present methods leverage high-rate, repetitive pressure waves, such as pressure waves of about 2.27 GPa, generated by a laser shockwave, to compact and structurally alter SWCNT networks, eventually transforming them into multilayered graphene structures. A unique mechanistic feature of the present methods is the gradual, controlled unzipping of SWCNT bundles, triggered by intense shockwave compaction, which facilitates their evolution into double-layer and multi-layer graphene-related structures.

The present methods are scalable, highly effective, and rapid. The entire transformation process only takes about a minute. The process can be easily scaled up, such as by scanning the laser, for macroscale fabrication or modification to achieve large scale network structures.

The methods use a low-temperature approach. No additional heating process is required, as the entire laser shockwave compaction process can be performed at room-temperature in an ambient environment. The methods are chemical-free. No hazardous chemicals are required, making the methods a cleaner and more sustainable alternative to conventional chemical oxidation methods. The methods are precise and controllable. The pressure wave per laser pulse can be precisely controlled, such as over the range from about 1 MPa to about 10 GPa, by adjusting laser power intensity and pulse duration. The transformation process from SWCNTs to graphene structures can be engineered to produce desired functional properties, including electrical and thermal conductivity. The process can increase the electrical and thermal conductivities of SWCNTs by up to 2.6 and 7 times, respectively.

The present technology has many useful applications. It can be used in the automotive industry, in batteries and energy-related applications, in advanced composite materials, and in electronic devices. Some specific applications are described below.
Battery Anode Materials. The present graphene structures can be used as anode components for various types of batteries, including lithium ion batteries, solid-state batteries, all-carbon batteries, and silicon anode-based batteries. The present carbon nanomaterials can serve as both active materials and conductive additives.
Electric Heating Films. Graphene structures can be used in high performance electric heating films, providing efficient and uniform heat distribution.
Electronic Devices and Sensors. The present graphene structures can be integrated into electronic devices requiring high electrical and thermal conductivities, including sensors, ensuring enhanced sensitivity and stability.
Thermal management materials. Graphene structures can serve as high performance reinforcement for composite materials used in thermal management applications, offering high thermal conductivity, rapid thermal dissipation, and enhanced thermal stability for advanced engineering applications.
High-performance carbon-based fibers. The present graphene structures can be utilized in advanced fiber materials, improving mechanical strength, thermal stability, and electrical conductivity for various performance applications.

The present technology also can be summarized with the following list of features.
1. A method of preparing a graphene structure, the method comprising the steps of
   (a) providing a film deposited on a substrate, wherein the film comprises or consists of a plurality of single-walled carbon nanotubes (SWCNTs), wherein the film is covered with an ablative layer, and wherein the ablative layer is covered with a transparent shockwave reflective layer; and
   (b) irradiating the ablative layer with a series of laser light pulses, whereby each pulse produces shockwave compaction of the SWCNTs and at least a portion of the SWCNTs is converted into the graphene structure.
2. The method of feature 1, wherein step (b) comprises:
   (b1) formation of defects in the SWCNTs;
   (b2) unzipping of the SWCNTs to form open-edged graphene ribbons; and
   (b3) transformation of the open-edged graphene ribbons into said graphene structures.
3. The method of feature 1 or feature 2, wherein the graphene structures are at least in part multilayered, the multilayered graphene structures having an interlayer spacing of about 3.5 nm and from 2 to about 20 graphene layers, or from 2 to about 10 graphene layers.
4. The method of any of the preceding features, wherein a plurality of different graphene structures are produced, and the plurality of different graphene structures comprise hybrid nanotube-graphene structures.
5. The method of any of the preceding features, wherein individual graphene structures formed have a surface area from about 1000 nm² to about 100000 mm².
6. The method of any of the preceding features, wherein step (b) comprises using from about 50 to about 200 laser pulses with a power of about 1.13 GW/cm² per pulse, and wherein the laser light has a wavelength of 1064 nm.
7. The method of any of the preceding features, wherein the film provided in (a) is patterned, and optionally wherein the substrate is patterned.
8. The method of any of the preceding features, wherein the ablative film comprises a metal.
9. The method of feature 8, wherein the metal is selected from the group consisting of aluminum, copper, and nickel.
10. The method of any of the preceding features, wherein the transparent shockwave reflection layer comprises a material selected from the group consisting of borosilicate glass, optical glass such as N-BK7, quartz, and a transparent polymer material such as polymethylmethacrylate (PMMA).
11. The method of any of the preceding features, wherein the substrate comprises a material selected from the group consisting of alumina, copper, a polymer material, a ceramic material, silicon, and silicon dioxide.
12. The method of any of the preceding features, wherein electrical conductivity of the SWCNTs is increased at least about 2-fold, 2.5-fold, or 3-fold.
13. The method of any of the preceding features, wherein thermal conductivity of the SWCNTs is increased at least about 5-fold, 6-fold, 7-fold, 8-fold, 9-fold, or 10-fold.
14. The method of any of the preceding features, wherein step (b) comprises scanning the laser across the film.
15. The method of any of the preceding features, further comprising, prior to step (a) and wherein the substrate is patterned, depositing the SWCNT film onto the patterned substrate whereby the SWCNT film is patterned.
16. The method of any of the preceding features, further comprising patterning the substrate.
17. The method of any of the preceding features, wherein the method does not include use of chemical vapor deposition and does not include use of temperature higher than 120° C.
18. The method of any of the preceding features, wherein the film provided in (a) does not contain multiwalled carbon nanotubes.
19. The method of any of the preceding features, wherein the graphene structure is essentially devoid of SWCNT structure.
20. The method of any of the preceding features, wherein the graphene structure forms a junction between two or more separate SWCNT networks.
21. The method of feature 20, wherein the graphene structure comprises covalently continuous graphene-SWCNT hybrid structures.
22. A graphene structure produced by the method of any of the preceding features.
23. The graphene structure of feature 22, wherein the graphene structure is selected from the group consisting of a graphene monolayer, a graphene bilayer, a graphene multilayer, a graphene monolayer-SWCNT hybrid, a graphene bilayer-SWCNT hybrid, a graphene multilayer-SWCNT hybrid, and combinations thereof.
24. The graphene structure of feature 22 or feature 23, wherein the graphene structure comprises one or more covalently continuous graphene-SWCNT hybrid structures.
25. An electrically or thermally conductive pathway, circuit, or coating comprising one or more covalently continuous graphene-SWCNT hybrid structures.
26. The electrically or thermally conductive pathway, circuit, or coating of feature 24, wherein the one or more covalently continuous graphene-SWCNT hybrid structures are made by a method comprising the method of any of features 1-21.
27. A device or product comprising the graphene structure of any of features 22-24 or the electrically or thermally conductive pathway, circuit, or coating of feature 25 or 26.
28. The device or product of feature 27, wherein the device or product is selected from the group consisting of a nanoelectronic or microelectronic circuit, chip, or device, a processor, a memory device, a flexible device, a display, a sensor, an electrically conductive coating, a thermally conductive coating, and a membrane.
29. A device for preparing a graphene structure from SWCNT by laser shockwave compaction, the device comprising:
   a substrate comprising a film deposited on an upper surface of the substrate, wherein the film comprises a plurality of SWCNT;
   an ablative layer disposed over the film;
   a transparent shockwave reflective layer disposed over the ablative layer; and
   a laser configured to apply a series of light pulses through the transparent shockwave reflective layer and onto the ablation layer.
30. The device of feature 29, wherein the substrate comprises alumina, copper, a polymer material, a ceramic material, silicon, or silicon dioxide; wherein the ablative layer comprises aluminum, copper, or nickel, and wherein the transparent shockwave reflective layer comprises borosilicate glass, optical glass such as N-BK7, quartz, or a transparent polymer material such as polymethylmethacrylate (PMMA).
31. The device of feature 29 or feature 30, further comprising a scanning mechanism that allows the laser pulses to be scanned across an area occupied by the film.

### BRIEF DESCRIPTION OF DRAWINGS

FIG. 1A-1 is a schematic representation of an apparatus for transforming SWCNTs into graphene structures using laser shockwave compaction. FIG. 1A-2 is a schematic representation (left side) of an embodiment of an apparatus for transforming SWCNTs into graphene structures, with an enlargement (right side) of the shockwave generation and SWCNT transformation zone. FIGS. 1B-1E show scanning electron micrographs (SEM, top row) and transmission electron micrographs (TEM, bottom row) of a SWCNT film after 0, 50, 100, and 200 laser pulses, respectively. Arrows in FIGS. 1D and 1E indicate unzipped SWCNTs. FIG. 1F shows schematic representations of the nanostructures observed in FIGS. 1B-1E.

FIGS. 2A-2E show crystal structure analysis of graphene structures formed by laser shockwave compaction. High resolution TEM (HRTEM) images are shown for multilayered graphene structures (MLG, FIG. 2A), a double-layer graphene (DLG) structure (DLG, FIG. 2B), and MLG structures formed after 200 pulses (FIG. 2C) of laser shockwave compaction. The inset in FIG. 2C shows the intensity line profile measured along the dashed line; the average interlayer distance is 3.53 Å. FIG. 2D presents a selected area electron diffraction (SAED) pattern of a MLG structure. FIG. 2E shows representative HRTEM images of carbon lattice in graphene structures. The inset image at the top-right is a magnified view showing the distinctive honeycomb carbon lattice of graphene. At the bottom-right is the corresponding Fast Fourier Transform (FFT) pattern from a DLG structure.

FIGS. 3A-3D show Raman spectra of the D- and G-bands before and after laser shockwave compaction, measured at an excitation wavelength of 532 nm. FIG. 3A shows Raman spectra of the D- and G-bands. FIG. 3B shows frequency changes of the deconvoluted G+-band. FIG. 3C shows IG−1/IG+, IG−2/IG+, and IG−3/IG+ changes as a function of the number of laser pulses. FIG. 3D shows changes in ID/IG+ with the number of laser pulses. Error bars represent the standard deviation from the mean, and each group consists of 15 sample points. Lorentzian curve fitting was carried out to determine the accurate peak position and intensity, and all spectra were normalized with the G+-band. Dashed lines in spectra indicate each peak position of pristine SWCNTs before the structural transformation.

FIGS. 4A-4D show comparison of the Raman spectra of the radial breathing mode (RBM) and 2D-band of SWCNTs before and after structural transformation, measured at an excitation wavelength of 532 nm. FIG. 4A shows Raman spectra of RBM before and after structural transformation. FIG. 4B shows changes in the IRBM/IG+ as a function of the number of laser pulses. FIG. 4C shows Raman spectra of the 2D-band before and after structural transformation. FIG. 4D shows the evolution of A2D/AG+ as a function of laser pulses. Error bars represent the standard deviation from the mean, and each group consists of 15 sample points. Lorentzian curve fitting was carried out to determine the accurate peak position and intensity, and all spectra were normalized with the G+-band. Dashed lines in spectra indicate each peak position of pristine SWCNTs before the structural transformation.

FIGS. 5A-5D show changes in the electrical and thermal properties of MLG-rich networks as a function of the number of laser pulses. FIG. 5A shows changes in electrical conductivity and ID/IG+ as a function of pulse number. FIG. 5B shows changes in in-plane thermal conductivity and ID/IG+ along with laser pulses. FIG. 5C shows increases in volumetric heat capacity with increasing number of laser pulses. FIG. 5D shows a comparison of thermal conductivity increase ratio as a function of the electrical conductivity increase factor before and after structural transformation with previously reported processing techniques [11,28,62,67-69].

FIGS. 6A-6E show estimation of processing temperature during laser-induced shockwave compaction. FIGS. 6A and 6C are schematic illustrations of the experimental setup for (FIG. 6A) direct laser ablation of a Ag layer and (FIG. 6C) laser shockwave compaction. FIGS. 6B and 6D present photographs of temperature-sensitive paper before and after (FIG. 6B) direct laser ablation and (FIG. 6D) laser shockwave compaction. FIG. 6E shows photographs of temperature-sensitive papers heated to 100° C., 120° C., and 180° C. on a hotplate for comparison.

FIG. 7 shows HRTEM images of SWCNT networks after 200 pulses of laser shockwave compaction. Low- (left image of each pair) and high-magnification (right image of each pair) HRTEM images of sixteen randomly chosen locations across the TEM grid of laser-compacted SWCNTs are shown. Graphene structures were observed in 12 out of 16 randomly chosen locations, while damaged SWCNTs were dominantly observed in the remaining 4 locations, resulting from the intense and repetitive nature of the shockwave compaction process. The scale bars in the low- and high-magnification images represent 200 nm and 5 nm, respectively.

FIGS. 8A-8D show representative HRTEM images of SWCNT-graphene structure networks after 200 cycles of laser shockwave compaction.

FIGS. 9A-1 and 9A-2 show representative cross-sectional SEM images of SWCNTs with increasing number of laser pulses. FIG. 9B shows corresponding changes in film thickness based on the SEM observations in FIGS. 9A-1 and 9A-2. FIG. 9C shows variations in sheet resistance of the SWCNT films before and after laser-induced shockwave compaction.

FIG. 10 shows TEM images of transformed multi-layer graphene structures after 200 pulses of laser shockwave compaction. The widths of SWCNTs residues and unzipped SWCNTs range from 2.5 to 5.2 nm, which corresponds to the circumference of pristine SWCNTs (3.77 to 5.34 nm) when unzipped.

FIG. 11 shows interlayer distance measurements of multilayered graphene structures. HRTEM images (left) and corresponding intensity line profiles (right) of the transformed multilayered graphene are presented. The interlayer spacings were determined based on intensity line profiles using TEM imaging analysis software (TIA). The overall interlayer spacings range from 3.25 to 3.74 Å.

FIG. 12 shows a SAED pattern of pristine SWCNT networks before laser shockwave compaction. The characteristic SAED patterns of (100) and (110) crystal planes of pristine SWCNTs were observed with a lattice spacing of 2.05 Å and 1.21 Å, respectively.

FIGS. 13A-13C show resonant Raman spectra of the D- and G-bands before and after laser shockwave compaction, measured using 785 nm laser excitation. FIG. 13A shows Raman spectra of the D- and G-bands. FIG. 13B shows changes in the IG−1/IG+, IG−2/IG+, and IG−3/IG+ ratio as a function of laser pulse number. FIG. 13C shows changes in ID/IG+ with increasing laser pulses.

FIGS. 14A-14B show Raman spectra of the RBM before and after laser shockwave compaction, measured using 785 nm laser excitation. FIG. 14A shows Raman spectra of RBM before and after structural transformation. FIG. 14B shows changes in the IRBM/IG+ as a function of laser pulse number.

FIG. 15 shows thermal conductivities of pristine and laser-compacted SWCNT films.

FIGS. 16A-16H show multiscale electron dispersion spectroscopy (EDS) analyses of transformed MLG-rich thin films after 200 pulses of laser shockwave compaction. High angle annular dark field imaging scanning transmission electron microscopy (HAADF-STEM) images (FIGS. 16A, 16D), EDS elemental mapping (FIGS. 16B, 16E), and EDS spectra (FIGS. 16C, 16F) are shown at the nanoscale. A SEM image of a compacted film on a Si substrate is shown in FIG. 16G, and a corresponding EDS spectrum (FIG. 16H) are shown at the microscale. Only negligible Al signals were detected across both nano- and micro-scale regions after compaction.

FIGS. 17A-17E-1 and 17E-2 show representative frequency domain thermal reflectance (FDTR) sensitivity and measured phase lag curves for measuring thermal properties of the SWCNT films before and after structural changes. FDTR sensitivity curves of (FIG. 17A) pristine SWCNT networks and (FIG. 17B) SWCNT networks subjected to 100 pulses of laser shockwave compaction are shown. FIGS. 17C and 17D show representative FDTR phase data (symbols) and best-fit curves (lines) of (FIG. 17C) pristine SWCNT networks and (FIG. 17D) SWCNT networks subjected to 100 pulses of laser shockwave compaction. FIGS. 17E-1 and 17E-2 show thickness changes of SWCNT films as a function of laser pulse number.

### DETAILED DESCRIPTION

The present technology provides novel, one-step, chemical-free methods for the transformation of single-walled carbon nanotube (SWCNT) networks into multilayer graphene structures at relatively low temperatures (<120° C.). This transformation uses high rate repetitive pressure waves generated by a laser shockwave to compact and structurally alter the SWCNT networks. A unique feature of these methods is the controlled unzipping of defective SWCNT bundles, triggered by the intense shockwave compaction, which facilitates their evolution into graphene layers. This transformation leads to an increase in thermal conductivity and electrical conductivity, making use of the enhanced transport properties of the resulting graphene networks. The technology provides scalable synthesis of graphene structures and an approach for transforming SWCNTs into graphene structures and networks of graphene structures and graphene-SWCNT hybrid structures. It opens new avenues for advanced applications in electronics, thermal management, and energy storage by performing in situ graphene synthesis and finely tuning the junctions between SWCNT and graphene networks.

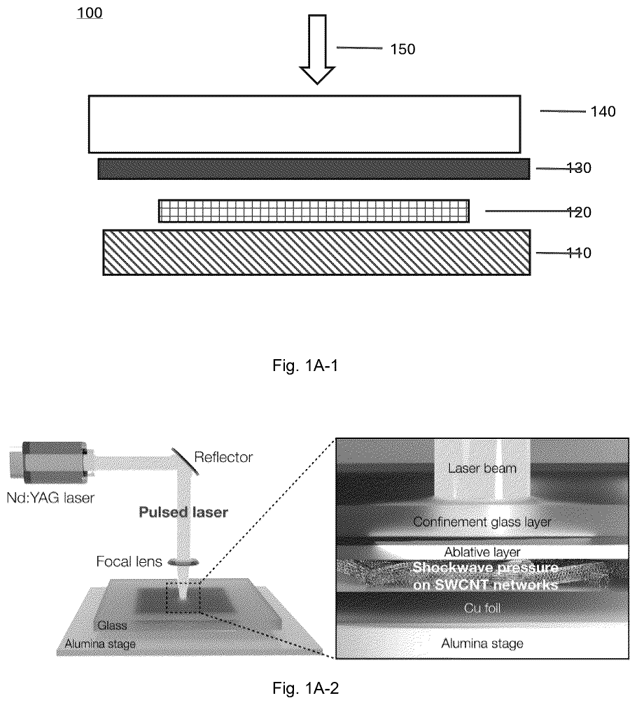

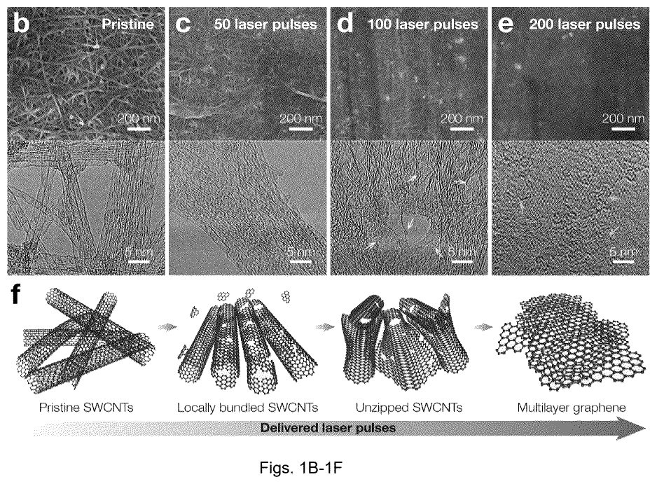

Laser-induced shockwave compaction has been previously reported for carbon nanotubes [27], but the methodology was applied only to double-walled carbon nanotubes, which did not unzip or form graphene sheets or other discrete graphene structures in response to shockwave compaction; laser shockwave compaction methodology has not previously been applied to SWCNT. A high-pressure shockwave, such as having a pressure from about 1 MPa to about 10 GPa, can be generated through the expansion of plasma, which is created when the absorbing materials are ablated by a pulsed laser. In the present technology, this dynamic shock loading leads to irreversible structural transformation of SWCNTs into double-layer and multilayer graphene in a highly effective and scalable way (see FIGS. 1A-1-1F). The entire transformation process can be achieved in a few minutes in remarkably low temperature environments (such as a highest locally achieved temperature <120° C.). The resulting graphene structures can be structurally characterized using scanning electron microscopy (SEM), high-resolution transmission electron microscopy (HRTEM), selected area electron diffraction (SAED), and Raman spectroscopy. Using these techniques, it was found that the structural evolution was initiated by the cumulative unzipping of defective SWCNT bundles under the highly repetitive shockwave compaction, and the unzipped SWCNTs or cracked carbon lattice coalesced into double-layer graphene (DLG), few-layer graphene (FLG), and multilayer graphene (MLG), or a combination of these, with lateral sizes up to hundreds of nanometers (FIGS. 1B-1E). These structural transitions were accompanied by significant enhancement in both electrical and thermal conductivity, which were increased up to 2.6 and 7 times, respectively. This technology can be used to develop advanced applications, such as in electronic and energy storage devices, for example by engineering junctions between SWCNTs and graphene to form a seamless network.

According to the present technology, graphene networks containing double-layer graphene and/or multilayer graphene can be produced by unzipping and coalescence of SWCNT networks using laser-induced shockwave compaction. The evolution of structural transformations was studied comprehensively, by HRTEM, SEM, and Raman spectroscopy. It was observed that defective bundles are introduced across the SWCNT random networks at an early stage of the structural transition (i.e., 25-50 pulses). Upon further laser shockwave compaction (i.e., 100-150 pulses), crack propagation was initiated by defective and bundled SWCNTs, which induced the unzipping of the SWCNTs at the middle stage of structural transformation. When the subsequent highly repetitive pulses of laser compaction were applied, up to 200 pulses, the unzipped SWCNT bundles coalesced into double-layer to multi-layer graphene. As a result, the transformed MLG network exhibited a sevenfold enhanced thermal conductivity (66.25±7.16 Wm⁻¹K⁻¹) and 2.6-fold increased electrical conductivity (0.18±0.06 MSm⁻¹), emphasizing the superior transport properties of the resulting graphene networks. Thus, the present methods are capable of transforming SWCNT networks into multilayer graphene networks at relatively low temperatures (<120° C., or even <110° C., 100° C., 90° C., 80° C., 70° C., or 60° C.) within a few minute process taking only minutes (such as <20, <10, or <5 minutes, or even <1 minute). Such methods enable the engineering of seamless junctions containing heterostructures of SWCNTs and graphene in a highly effective and scalable way, which has enormous potential for fabricating advanced electronic devices and energy storage systems.

As used herein, a SWCNT film or SWCNT network refers to a thin film comprising or consisting of single walled carbon nanotubes (SWCNT) deposited on a substrate, foil, or other solid structure, existing prior to or during laser shockwave compression treatment. The film or network can include overlapping individual SWCNT, or it can be essentially devoid of overlapping SWCNT. The SWCNT in the film or network can possess structural defects, or it can be essentially devoid of structural defects. The SWCNT in the film or network can be a single layer of SWCNT in average thickness, or if containing overlapping SWCNT, can have a desired average thickness of 2, 3, 4, 5, 10, or more times the average SWCNT diameter. Alternatively, the SWCNT film or network can have a thickness from about 50 nm to about 250 nm. The SWCNT in the film or network can have any desired length, such as from about 100 nm to about 5000 nm. The SWCNT film or network can be essentially devoid of other types of carbon nanostructures, or it can contain small amounts (e.g., less than about 10%, 5%, 3%, 2%, 1%, 0.5%, or 0.1% by weight) of other carbon nanostructures such as multiwalled carbon nanotubes (MWCNT) or other carbon nanostructures. The SWCNT film or network can be spread over an area of a substrate without defining a specific form or outline, or the SWCNT film or network can be confined to vias, trenches, or other structures defined by the substrate on which it is deposited. The SWCNT in an SWCNT film or network can be arranged in parallel or in bundles or can be randomly arranged.

A graphene structure or network produced using the present technology comprises or consists of one or more carbon nanostructures, each having one or more 2D layers of covalently linked carbon atoms, each layer forming a hexagonally arranged honeycomb-like structure. A graphene structure or network can possess one or more portions, each having a variation of graphene structure, such as a different number of individual graphene layers that can be stacked to form a bilayer (or dilayer) or a multilayer having graphitic structure. In a graphene structure or network, different such portions can have different variations of 2D graphene, such as different numbers of stacked graphene layers. A graphene structure or network can also contain, or can be essentially devoid of, fully or partially intact SWCNTs. Partially intact (e.g., partially unzipped) SWCNT can be covalently coupled at one or more locations, through carbon-carbon bonds, with a graphene layer, thereby forming a graphene-SWCNT hybrid structure (also referred to herein as a covalently coupled hybrid structure).

The graphene structures produced according to the present technology, including various graphene structures having from one individual layer to several (e.g., 2, 3, 4, 5, 6, 7, 8, 9, 10, or more) stacked 2D graphene layers as well as hybrid structures and junctions between such graphene structures and SWCNT or other carbon nanostructures, have many uses. The graphene structures can be used in anodes for various types of batteries, including lithium-ion batteries, solid-state batteries, all-carbon batteries, and silicon anode-based batteries. In such batteries, graphene structures of the present technology can serve either as conductive materials or additives, or they can be used in active materials. The present graphene structures also can be used in electric heating films by providing efficient and uniform heat distribution. The graphene structures can be used as components of electronic sensor devices, by providing high electrical and thermal conductivities, offering enhanced sensitivity and stability for such devices. Graphene structures also can form the sensing element of sensors because they can be functionalized using various covalent and non-covalent chemistries known to the skilled person. Graphene structures can be used in thermal management applications, where they offer high thermal conductivity, rapid thermal dissipation, and enhanced thermal stability for advanced engineering applications. Further, the present graphene structures can be used to fabricate high performance carbon-based fibers, where they improve mechanical strength, thermal stability, and electrical conductivity.

Process for Forming Graphene Structures from SWCNT

An apparatus 100 for transforming SWCNT into graphene structures is shown schematically in FIG. 1A-1. A film containing SWCNT 120 is deposited onto substrate 110. Preferably the SWCNT film has a thickness from about 50 nm to about 250 nm. More preferably, the film thickness is about 100 nm or greater. The SWCNT are preferably at least 99% pure by weight, and the total residual metal content is <0.5%, such as less than about 0.34%, by weight. The substrate is sufficiently robust and rigid that it can withstand the compressive shock waves absorbed by the SWCNT without breaking down or deflecting. Optionally, another layer or structure such as a metal foil, chip, template, or device (not shown) can be placed between the substrate and the SWCNT. A layer of ablative material 130 (also referred to herein as the ablative layer or ablation layer) is placed above the SWCNT film. Optionally, the ablation layer has a light absorbing coating on the side facing away from the SWCNT film to enhance absorption of the laser light. Shockwave reflectance layer 140 (also referred to herein as the confinement layer or confinement glass layer) is disposed above ablative layer 130. The shockwave reflectance layer is transparent (e.g., transmittance at least 90%, 95% or 99%) to the wavelength of laser light used to generate the shockwaves, and it is robust enough to reflect the pressure wave generated by plasma formation caused by the laser pulses back down towards the SWCNT film. Laser light pulses 150 are directed through the transparent shockwave reflectance layer and into the ablative layer, where they are absorbed, causing a burst of plasma formation and expansion to generate the desired shockwave compaction, which is reflected downward onto the ablative layer and then onto the SWCNT film. The laser light is generated by a pulsed laser (not shown) and directed towards the apparatus using suitable optical elements such as one or more mirrors, lenses, and/or optical fibers. Control electronics can be used to perform the shockwave compression according to a program, and the laser light optionally can be controlled by a scanning mechanism that distributes the light pulses across the SWCNT film. If desired, the apparatus can be temperature controlled and/or placed into a controlled atmospheric chamber, such as a chamber containing an inert gas atmosphere to prevent undesired chemical reactions or containing a gas for driving an intended chemical reaction.

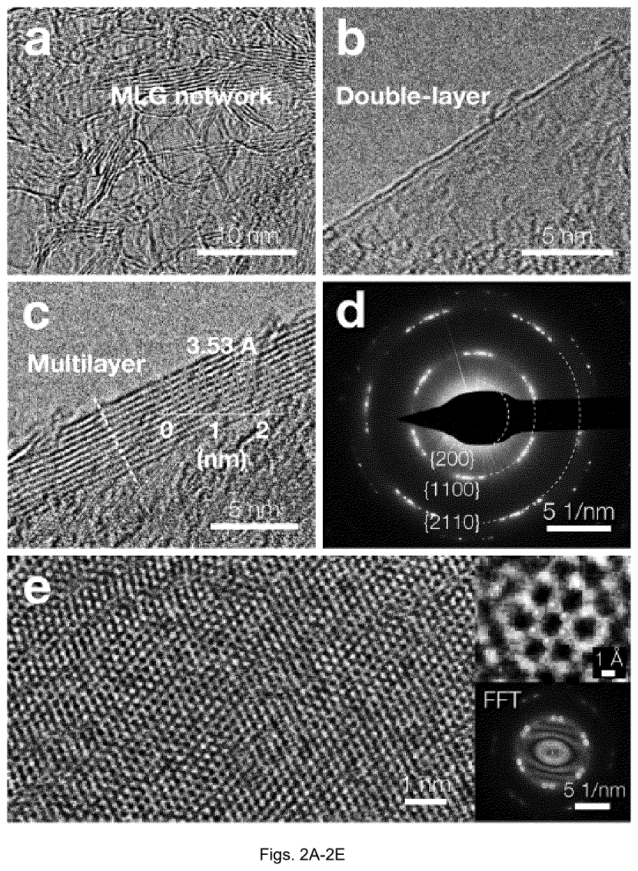

FIG. 1A-2 shows an embodiment of the apparatus of FIG. 1A-1. In this embodiment, the laser pulses are provided by a Nd:YAG laser and focused onto a borosilicate glass confinement layer. The ablative layer consisted of an aluminum foil coated with black paint on the side facing the confinement layer. The SWCNT film was deposited on a copper foil, which was placed onto an alumina substrate. The apparatus was used to generate the structures shown in FIGS. 1B-1E, and schematically represented in FIG. 1F. For further details see Example 1 below.

It is understood that the laser pulse parameters described herein can be varied and optimized for a desired use and to produce desired graphene structures. For example, variables than can be controlled and optimized include the type of laser, the pulse duration and frequency, grouping of pulses, power per pulse, power intensity or power density, pressure achieved per pulse, number of pulses, wavelength of light, area of the beam, and scanning of the beam. Preferably, the pressure created by the shockwave is at least about 2 GPa, as below that amount meaningful structural transformation of the SWCNT cannot be achieved, even by increasing the number of pulses. Preferably, the shockwave compression provides a pressure of about 2, about 2.1, about 2.2, about 2.27, about 2.3, about 2.4, about 2.5 GPa per pulse. It is noted that previous studies using static pressure require much higher pressures of 10-20 GPa to induce structural modifications of carbon nanotubes. Unexpectedly, the present use pulsed laser shockwave compaction requires much less pressure, and only simple equipment.

Further, the temperature of the SWCNT film and substrate, or of the entire apparatus, can be controlled, or ambient temperature can be used. The atmosphere surrounding the SWCNT, or the entire device, can be controlled, for example by using an argon or nitrogen atmosphere to avoid oxidation. Similarly, the materials and dimensions of the device components can be altered and optimized, including the substrate material and dimensions, the ablative material and dimensions, the shockwave reflective layer material and dimensions, and the separation of the layers, such as the gap between the shockwave reflective layer and the ablative layer and the gap between the ablative layer and the SWCNT film or substrate. The substrate itself can be patterned or unpatterned. A patterned substrate can be prepared by depositing SWCNT, either aligned or non-aligned, into vias or conforming to chemically defined pathways on the substrate, so as to yield graphene pathways in a circuit or junctions between graphene structures and other components of a circuit, sensor, or chip. The substrate also can be an article to be coated, partially or entirely, by the graphene structures formed through laser shockwave compaction.

The results of altering such process variables can be checked using various properties of the resulting graphene structures, such as structure by electron microscopy and electron diffraction, Raman spectroscopy, electrical conductivity, and thermal conductivity.

The use of laser shockwave compaction has been described for other materials. See, for example, the publications of A. K. Gujba et al. (Materials 7, 7925-7974 (2014), “Laser Peening Process and Its Impact on Materials Properties in Comparison with Shot Peening and Ultrasonic Impact Peening”), D. Devaux et al. (J. Appl. Phys. 74, 2268-2273 (1993), “Generation of shock waves by laser-induced plasma in confined geometry”), and P. Peyre et al. (Optical and Quantum Electronics 27, 1213-1229 (1995), “Laser shock processing: a review of the physics and applications”), including the methods described therein, which are hereby incorporated by reference in their entireties.

### Structural Characterization of the Transformed Carbon Structures

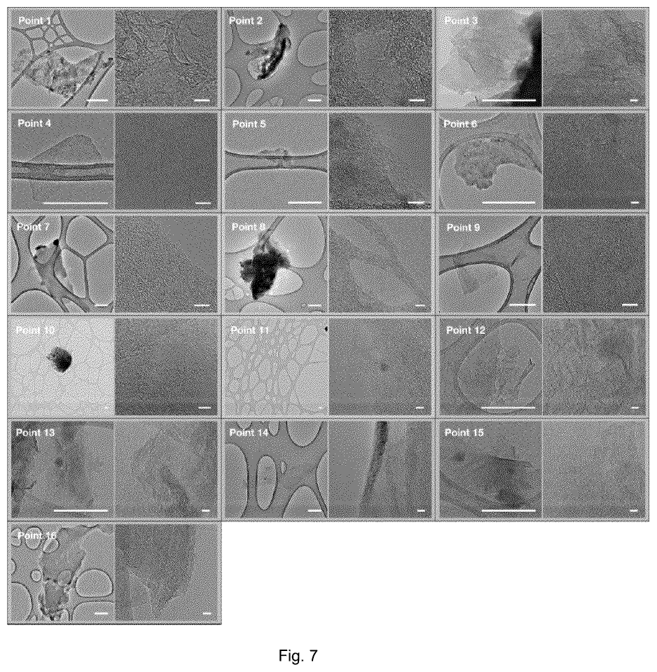

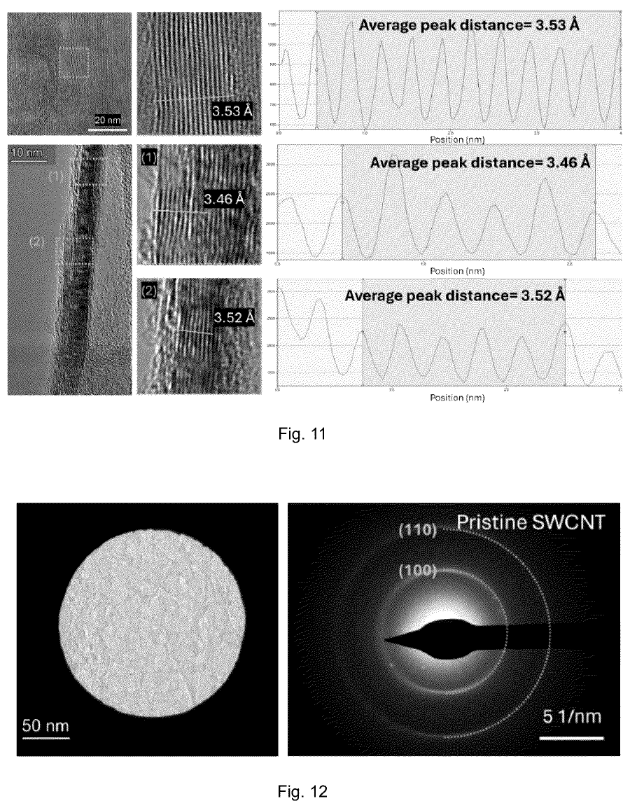

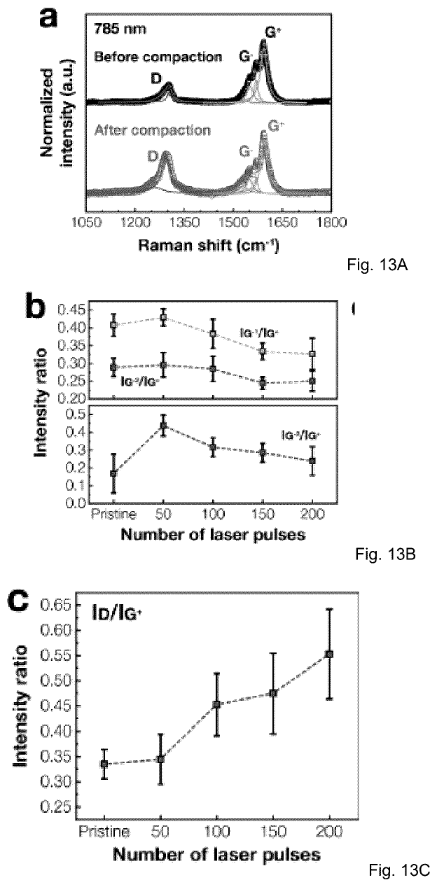

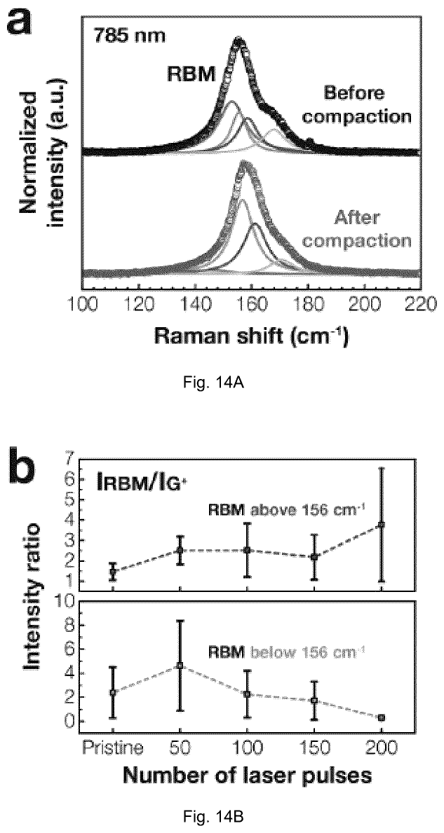

After 200 pulses of laser-induced shockwave compaction, it was observed that the SWCNTs transformed into DLG and MLG with domain size up to the sub-micron scale (FIGS. 2A, 2B, and 7). To confirm structural transformation of SWCNTs into graphene, more definitive identifications were performed, as shown in FIGS. 2C-2E. The HRTEM image and corresponding intensity line profile of the transformed MLG give the clear lattice fringes with an average interlayer spacing of 3.53 Å, which is consistent with either MLG or graphitized CNTs [31-33] (FIGS. 2B, 2C, and 11).

FIGS. 2D and 2E show the electron diffraction patterns of SWCNTs before and after structural transformation. Before compaction, the characteristic SAED patterns of (100) and (110) crystal planes of pristine SWCNTs [34] were observed with a lattice spacing of 2.05 Å and 1.21 Å, correspondingly (FIG. 12). On the other hand, the distinctive sixfold symmetry patterns of the graphene/graphite structure [35-37] were detected from the transformed layered graphene structure (FIG. 2D). The two outermost patterns at 1.22 Å and 2.12 Å correspond to Miller-Bravais indices (hkil) of {2110} and {1100}, respectively [35-37]. Such multiple diffraction spots practically forming a ring suggest that the transformed structure is comprised of a few-layers of graphene and/or twisted relative to each other [38]. The main difference between FIG. 2D and FIG. 2E is that the diffraction spots of few-layer graphene (FIG. 2E) form a hexagonal shape, whereas FIG. 2D displays a broad ring shape. Additionally, the innermost pattern of {002} plane of graphene is observed at 3.55 Å in FIG. 2E, which matches with the interlayer spacing evaluated by the intensity line profile in FIGS. 2B and 2C. The HRTEM image in FIG. 2E reveals that the transformed graphene lattice presents a typical honeycomb carbon lattice in the graphene layer. The corresponding fast Fourier transform (FFT) pattern in FIG. 2E also shows bright spots forming two distinctive hexagons at {1201} and {1100} crystal planes, which indicate the twisted double-layer graphene. These observations confirm that the SWCNT random networks were successfully converted into graphene with different number of layers after applying the laser-induced shockwave compaction (i.e., 200 pulses).

It is believed that the number of layers or domain size of graphene directly depend on the original size of SWCNTs bundles in the early stage of laser shockwave compaction. Thin SWCNTs bundles with low SWCNTs density transformed into DLG or FLG. Thick bundles with high SWCNTs density have a higher probability of transforming into MLG.

### Electrical and Thermal Property Changes

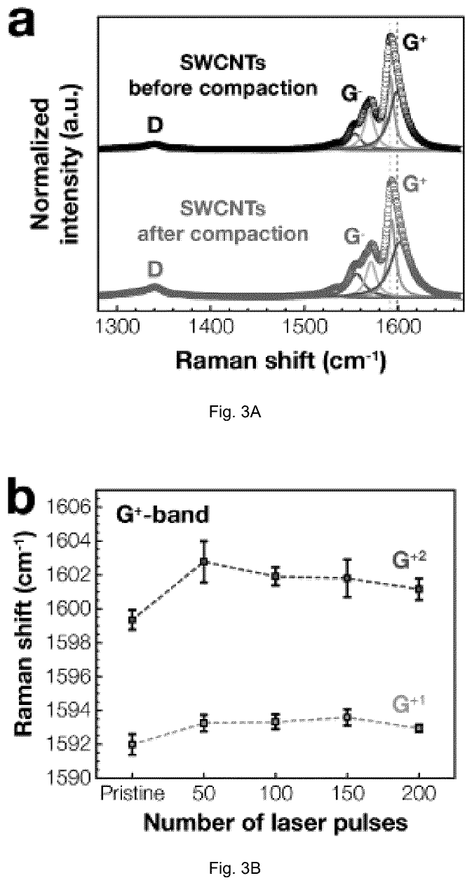

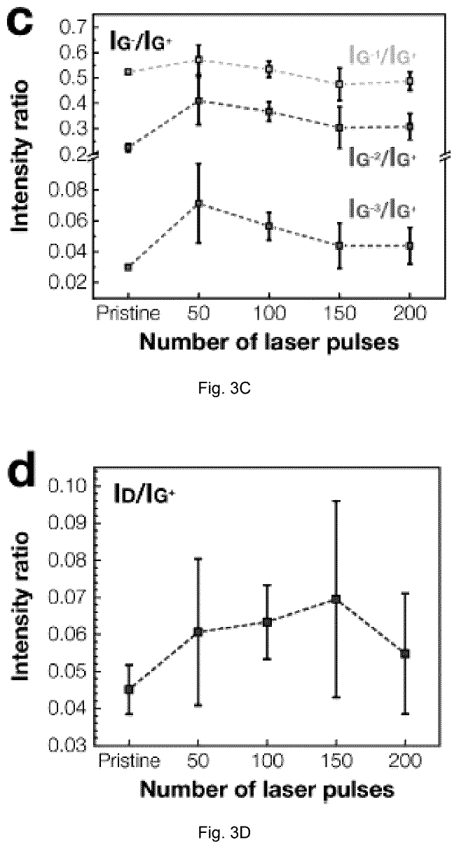

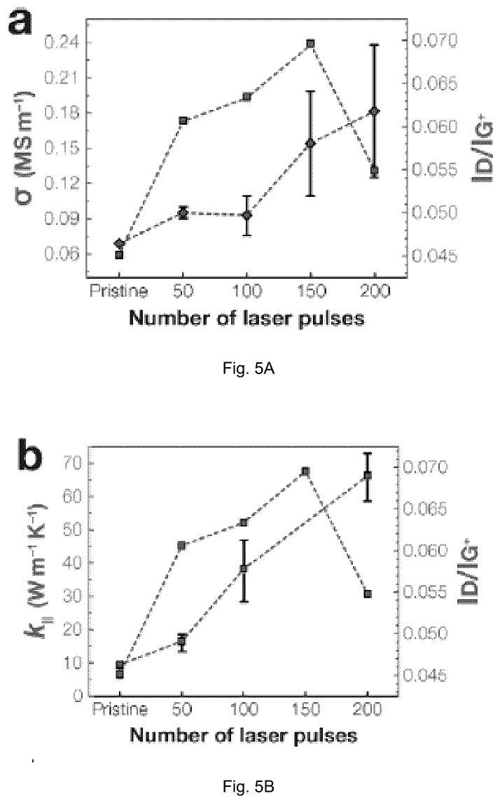

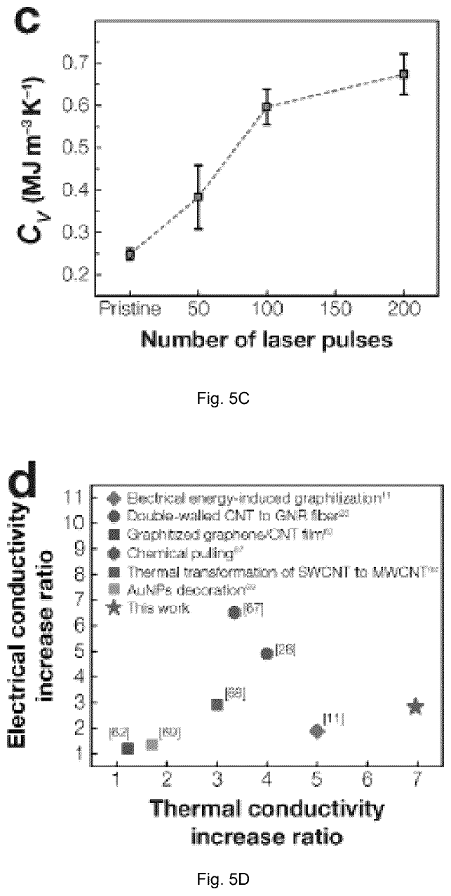

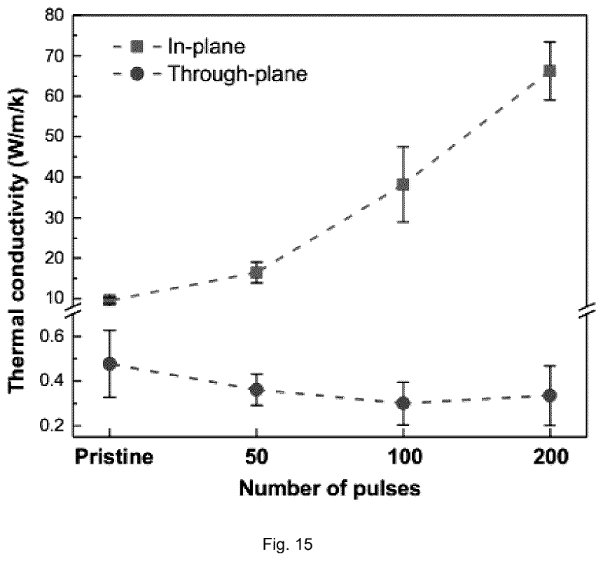

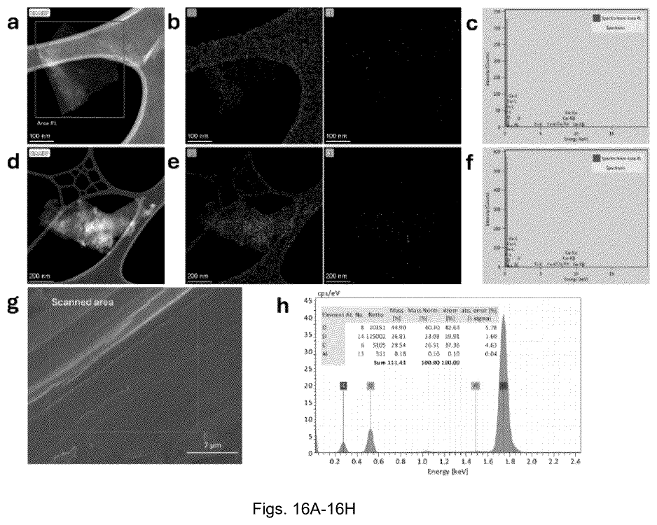

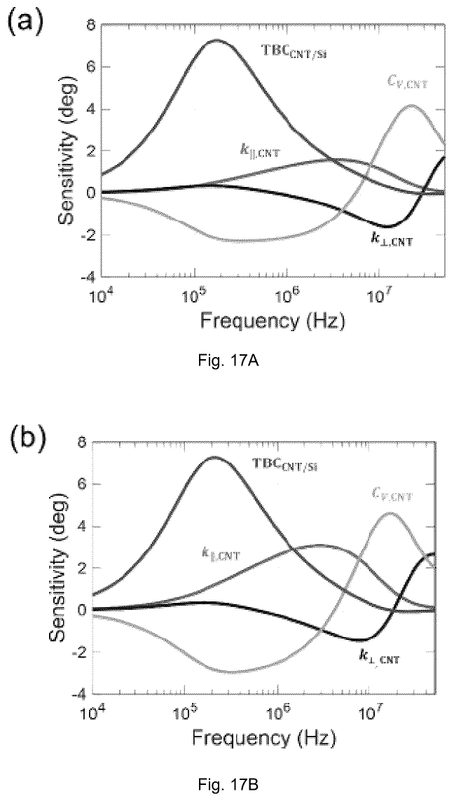

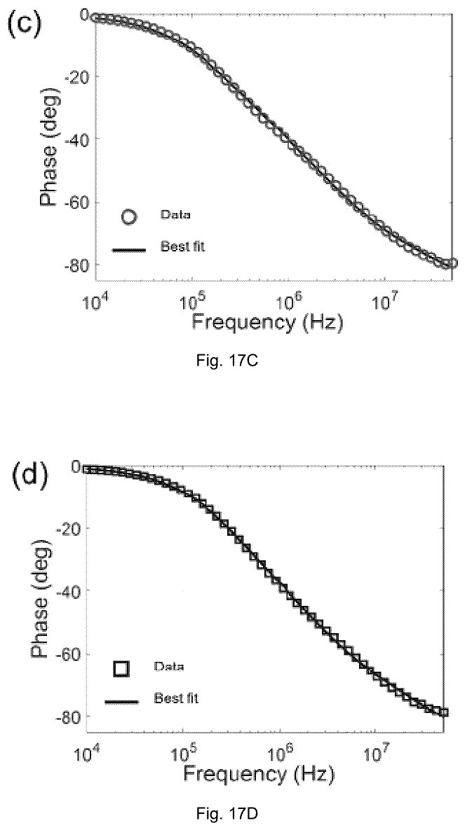

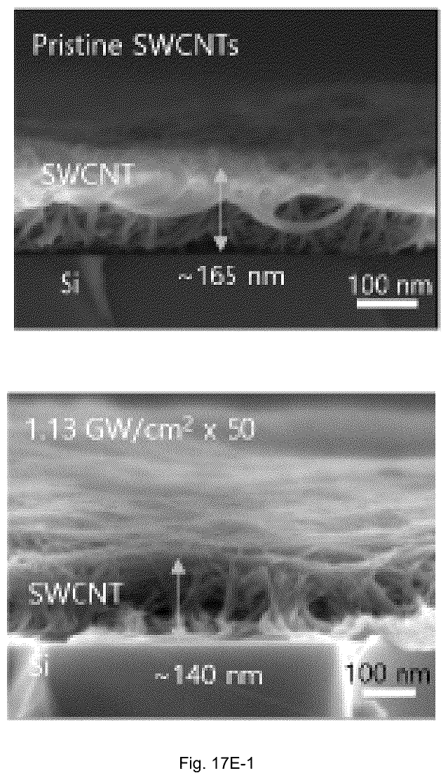

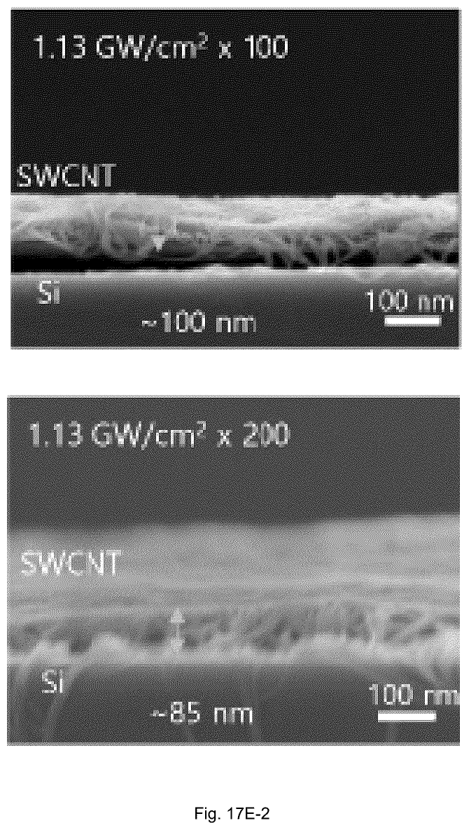

Notable improvements in electrical and thermal conductivities were observed as a function of pulse numbers, as shown in FIGS. 5A-5D. These results highlight the effectiveness of the laser shockwave induced-structural transformations and junction engineering of SWCNT networks. At the early and middle stages of the compaction (50 and 100 pulses), marginal enhancements were observed in both electrical and in-plane thermal conductivities (only the in-plane thermal conductivity, k∥, is discussed here due to the highly anisotropic nature of the SWCNT film, as illustrated in FIG. 15). As shockwave compaction progressed to 200 pulses, the transformed MLG network exhibited a 2.6-fold increase in electrical conductivity (from 0.068 to 0.18 MS m⁻¹), whereas the k∥ demonstrates a more pronounced enhancement, resulting in a sevenfold amplify from pristine SWCNTs (from 9.52 to 66.25 Wm⁻¹K⁻¹), as shown in FIGS. 5A and 5B. The limited increase in electrical and thermal conductivities at initial compaction was primarily attributed to the compaction induced bundling and alignment of SWCNTs, which reduces tube-tube contact resistance by removing the voids and rearranging the electron and phonon pathways more effectively throughout the film. However, the increase in defect density, as illustrated in FIGS. 1C, 1D, 5A, and 5B, hinders this effect and prevents significant improvements in the overall electrical conductivity of SWCNTs film. Based on the TEM observations (FIG. 1D), the initial graphitization of SWCNTs through unzipping began at 100 pulses, leading to the formation of a partially developed 2D layered structure within the network. This structure increases thermal conductivity by creating continuous phonon transport pathways and reducing thermal contact resistance through an increased contact area between tubes or tubes and layers followed by compaction. However, the process did not result in fully reconstructed or ordered sp² graphene formation, as evidenced by the increased defect density shown in FIGS. 3E, 5A, and 5B, which still hinders effective electron conduction. Subsequently, transformed MLG networks after 200 pulses create continuous and highly efficient 2D transport networks, reducing boundary scattering for phonons and enabling seamless sp² carbon structures that promote effective electron transfer, while persistent SWCNTs contribute additional conductivities, resulting in enhanced conductivity across the film. Remarkably, the transformed MLG networks demonstrated comparable improvement in transport properties, with thermal conductivity surpassing that of all other previous methods (FIG. 5D) [17,20,27,71-73]. This highlights the effectiveness of the laser shockwave compaction method in engineering the molecular structure and junctions within the networks.

### EXAMPLES

### Example 1. Methods

### SWCNT Film Fabrication and Shockwave Compaction Treatment

The pure SWCNTs solution (0.5 mg/ml of PureTubes, NanoIntegris) was spray-coated on copper foil (25 μm thickness, 99.8%, Alfa Aesar) to fabricate the SWCNTs thin film network. According to the data sheet [30] from NanoIntegris Technologies Inc., the diameter of as-purchased SWCNT is in the range of 1.2-1.7 nm, and with a length range of 100 nm to 4 μm. The fabricated SWCNT film was rinsed with deionized water and dried with Ar gas to remove the surfactant residues.

The as-prepared SWCNTs thin film on copper foil was placed between an alumina substrate as a supportive layer and a 100-μm thick aluminum foil (99.997%, Fisher Scientific) as an ablative layer. The overall experiment setup is shown in FIG. 1A-2. The ablative layer was coated with black paint to increase the absorbance of a laser beam. The quarter-inch thick borosilicate glass (McMaster-Carr) was used as the confinement layer on top of the ablative layer. The pulsed laser was generated by a Q-switched Nd:YAG laser system (wavelength λ=1064 nm, full width at half maximum FWHM=10 ns, pulse energy=1.8 J, YG980, Quantel, France) with an intensity of 1.13 GWcm⁻² (beam diameter was controlled to 4.5 mm, corresponding to an approximate pressure of 2.27 GPa for each pulse). Pulse rate was 10 Hz (10 pulses/s). To prevent damage to the sacrificial layer, it was replaced every 50 pulses (i.e., for 200 pulses, 4 changes).

### Laser Intensity and Pressure Calculation

The pulsed laser shockwave generated by the Nd:YAG laser system was 1.8 J per pulse, wavelength λ=1064 nm, and a duration of 10 ns (full width at half maximum, FWHM). The laser intensity was controlled by adjusting the laser beam size. The laser power intensity and corresponding shock pressure are determined by Equations (1) and (2). The experimental setup is shown in FIG. 1A-2.

$$Intensity of laser ( \frac{W}{{cm}^{2}} ) = \frac{Energy per pulse ( J )}{Pulse width ( s ) \times Beam area ( {cm}^{2} )} \qquad ( 1 )$$

$$Pressure ( GPa ) = 0.01 {( \frac{a}{2 a + 3} )}^{0.5} \times {\frac{2}{\frac{1}{{Z}_{1}} + ( \frac{1}{{Z}_{2}} )}}^{0.5} \times {I}^{0.5} \qquad ( 2 )$$

The diameter of beam waist was 4.5 mm. Z1 and Z2 are the acoustic impedance of borosilicate glass and aluminum, 1.26×10⁶ g·cm⁻²s⁻¹ and 1.73×10⁶ g·cm⁻²s⁻¹, respectively. a is the fraction of absorbed energy, typically 0.1 for a nanosecond-scale laser pulse. I is the laser peak intensity.

### Measurement of Heating During Laser Shockwave Compaction

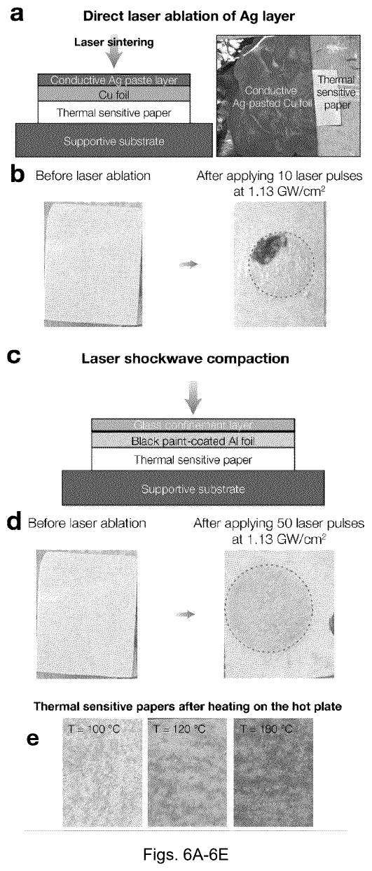

Thermal paper was placed between the ablative layer (Al foil) and a Cu foil to measure the temperature increase during laser shock compaction. The maximum number of pulses on each ablative layer is 50 to prevent the damage of the ablative layer. For this reason, the temperature increase was measured only for 50 pulses of laser shock compaction. As shown in FIG. 6D, only slight color changes in the thermal paper were observed after 50 pulses. Calibration of the thermal paper using a hot plate (see FIG. 6E) indicated that the increase of temperature was lower than 120° C. during laser-induced shockwave compaction.

### Characterization of Structural Transformation

The overall morphology of SWCNT networks before and after laser compaction was confirmed by a thermal field emission-scanning electron microscope (Supra 25 FE-SEM, Zeiss) at 3 kV. For the detailed structural analysis, an aberration-corrected transmission electron microscope (TEM, FEI Titan Themis 300) was used to obtain a direct crystalline structure at 300 kV.

To characterize the structural transformation of the SWCNTs into multi-layer graphene structure, Raman spectroscopy (Jobin Yvon HR 800, Horiba) was performed under different numbers of laser-induced shockwave compactions. Three samples per condition, each with a different number of pulses (i.e., 25, 50, 100, 150, and 200 pulses), were used for Raman characterization, and 7-8 random points were measured for each sample. The samples were excited by a 532 nm (2.33 eV) wavelength laser. To prevent damage to samples, the laser power was controlled to approximately 2 mW by applying a laser beam filter. The confocal hole diameter was set to 100 μm, and the exposure time was 3 s per spectrum with an accumulation number of 10.

### Electrical Conductivity Measurements

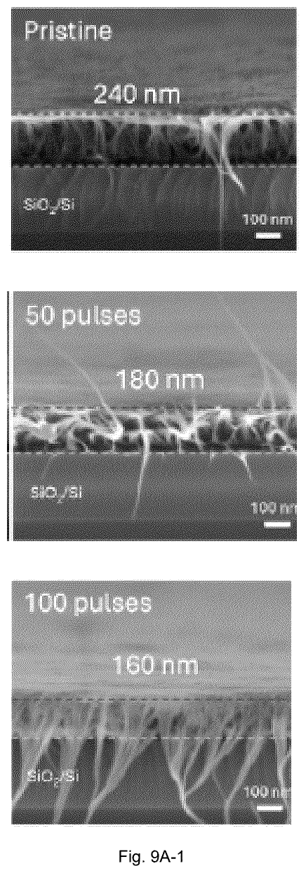

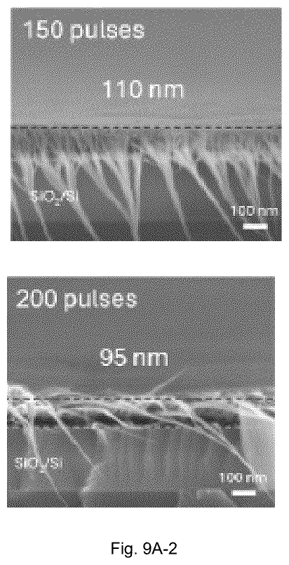

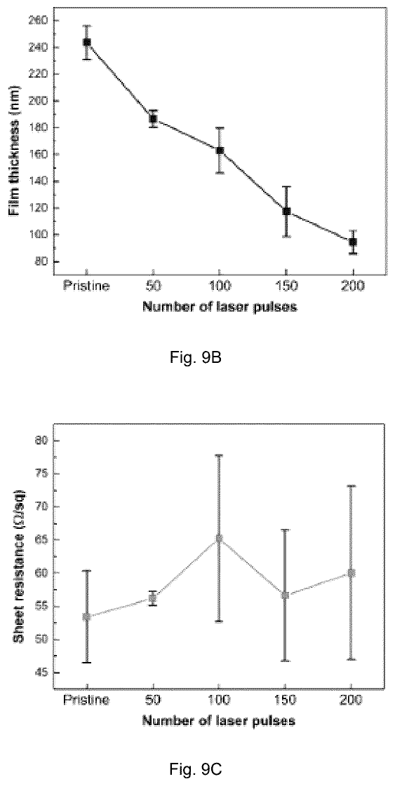

To measure the electrical conductivity, the pristine and laser compacted SWCNT films (3×3 mm in square shape) on Cu foil were transferred from Cu foil to 300 nm SiO₂/Si wafer using floating transfer method. The sheet resistance of transferred SWCNT films was measured by a probe station (Cascade Microtech) and a semiconductor analyzer (Agilent 4156C, Agilent Technologies) at room temperature. Four probes (probes A to D) landed on 4 corners of the films in a clockwise direction, two adjacent probes were used for current injections and another two adjacent ones as voltage detectors. For example, current IBC was injected into probe B and taken out of probe C, while the voltage V_{DA} measures as V_{A}-V_{D}, allowing for the calculation of the sheet resistance R_{BC,DA}. In the same manner, the sheet resistances R_{DA,BC}, R_{CB,AD}, R_{AD,CB}, R_{AB,CD}, R_{CD,AB}, R_{BA,DC}, and R_{DC,BA} were measured. The resistance in vertical and horizontal direction, overall sheet resistance, and overall resistivity can be written as

$${R}_{vertical} = \frac{{R}_{AB , CD} + {R}_{CD , AB} + {R}_{BA , DC} + {R}_{DC , BA}}{4} \qquad ( 3 )$$

$${R}_{horizontal} = \frac{{R}_{BC , DA} + {R}_{DA , BC} + {R}_{CB , AD} + {R}_{AD , CB}}{4} \qquad ( 4 )$$

$$e {\text{?}}^{- \frac{\cdot {R}_{vertical}}{{R}_{sheet}}} + e {\text{?}}^{- \frac{\cdot {R}_{horizontal}}{{R}_{sheet}}} = 1 \qquad ( 5 )$$

$$σ = \frac{1}{{R}_{sheet} \cdot t} \qquad ( 6 )$$

$$\text{?} \text{indicates text missing or illegible when filed}$$

where Rₛₕₑₑₜ is overall sheet resistance of the film, t is thickness of the SWCNTs film, and a is overall conductivity. Sheet resistance and thickness of SWCNT films before and after laser shock compaction are shown in FIGS. 9B and 9C.

### Thermal Conductivity Measurements Using the Frequency-Domain Thermoreflectance Method

The thermal properties of the pristine and structural transformed SWCNT films were characterized using frequency domain thermoreflectance (FDTR) method, an optical pump-probe technique used to measure thermophysical properties, including thermal conductivity (k), thermal boundary conductance (TBC), and volumetric heat capacity (pcₚ) [75-79]. Briefly, FDTR employs two continuous lasers, which are pump (405 nm) and probe (785 nm). The pump laser is digitally modulated and focused on the sample surface using a 10× objective lens to induce a periodic heat flux. An unmodulated probe laser, coaxially aligned with the pump through the same objective lens, monitors surface temperature response corresponding to the change in the reflectivity due to periodic heating. The unknown thermophysical properties are extracted by fitting the measured thermal phase lag of the probe beam to a multilayer heat diffusion model [81,82]. The 1/e² diameters of the focused pump and probe beams were 7.9 and 5.3 μm, respectively. For thermal characterization, a ~70 nm aluminum (Al) transducer was deposited onto the sample surface via electron beam evaporation to absorb the pump beam and maximize the reflected probe beam.

### Example 2. Morphological Characterization of the Structural Evolution of SWCNT

SWCNT films were directly deposited on copper (Cu) foil using the spray-coating method described above. Laser-induced shockwave compaction was applied to the SWCNT films and the resulting morphological changes characterized as a function of the number of laser pulses, each at an intensity of 1.13 GWcm⁻², which corresponds to an approximate pressure of 2.27 GPa per pulse. The laser shockwave induced structural transformation was achieved at a relatively low temperature (<120° C.), which was measured by an irreversible temperature recording paper (see above). The morphological and structural transformation of SWCNT networks depended on the number of pulses of laser shockwave compaction, as shown in FIGS. 1C and 1D. Randomly oriented individual tubes and small bundles with the presence of inherent defects were observed for the as-fabricated pristine SWCNT film before the compaction treatment (FIG. 1B). During repetitive laser shockwave compaction, a notable change in the surface morphology and structure of the films was observed (FIGS. 1C, 1D, and 1F). A significant thickness reduction of up to 61% was confirmed after applying 200 pulses of laser compaction, resulting in a highly dense and compacted structure (FIGS. 1E and 9B).

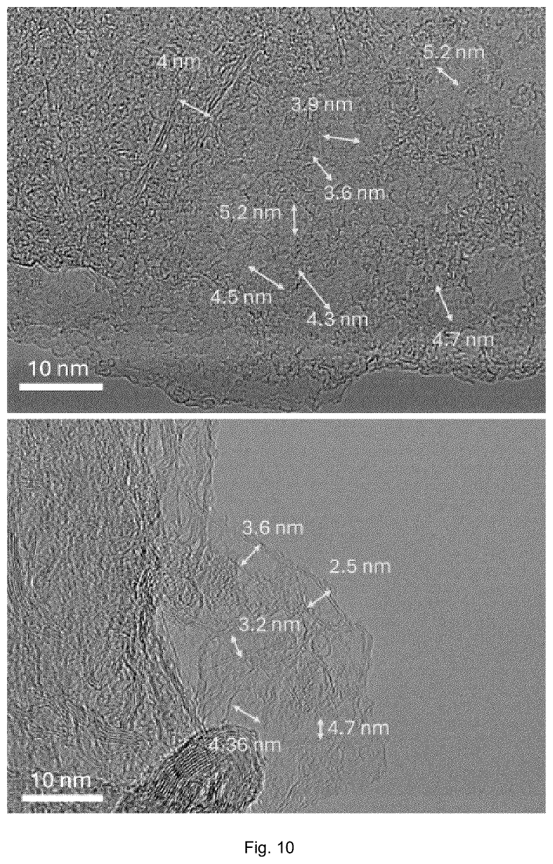

At the early stage of laser shockwave compaction (50 pulses), the randomly oriented pristine SWCNTs re-organized into locally bundled and more defective SWCNTs (FIG. 1C). Subsequently, the bundled or individual nanotubes were cracked and unzipped into open-edged GNR-like structure rather than a typical flattened GNR by repetitive high-pressure shockwave (100 pulses), as shown by arrows in FIG. 1D and schematically in FIG. 1F. This unzipping of SWCNTs under such high-energy impact follows an unzipping mechanism which has been observed in a previous study [29], where tube structure collapses and breaks from the center of the top wall and opens into a graphene layer. Additionally, the propagation of defects generated at the early stage of compaction, or the intrinsic defects of the as-purchased SWCNTs, also promote this unzipping process. Finally, these unzipped SWCNTs and cracked carbon lattices coalesced into a two-dimensional (2D) form of crystalline carbon, a layered graphene structure, after 200 pulses of laser-induced shockwave compaction (FIG. 1E). The formation of layered graphene structures (DLG and MLG) was confirmed by HRTEM (FIGS. 2A, 2B, 8A-8D, 10, and 11). Note that some persistent carbon residues of unzipped SWCNTs (indicated by arrows in FIGS. 1E and 10) did not transform into the 2D form of crystalline carbon. The width of these SWCNT residues ranged from 2.5 to 5.2 nm (FIG. 10), consistent with the circumference of the pristine SWCNTs (3.77 to 5.34 nm) when those are unzipped, which have diameters ranging from 1.2 to 1.7 nm [30]. These results suggest that the seeds of 2D carbon lattice formation originate from the unzipping of defective SWCNTs through laser shockwave compaction.

### Example 3. Raman Spectra of Transformed Carbon Structures

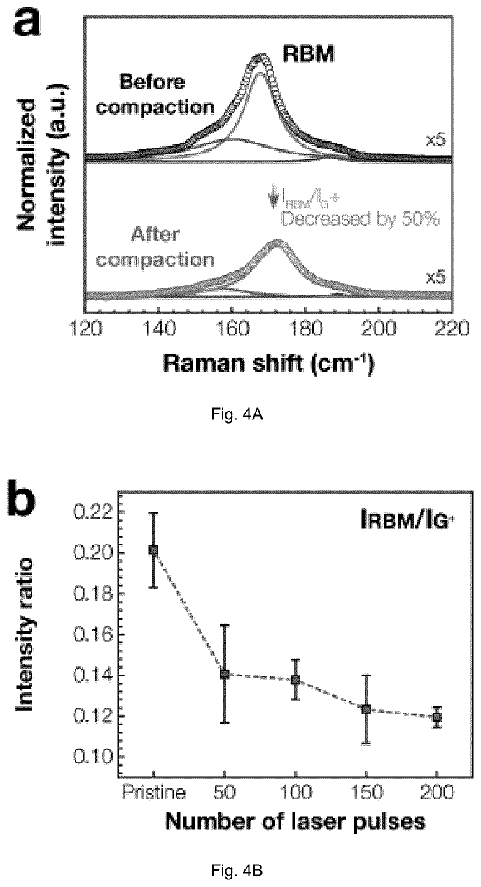

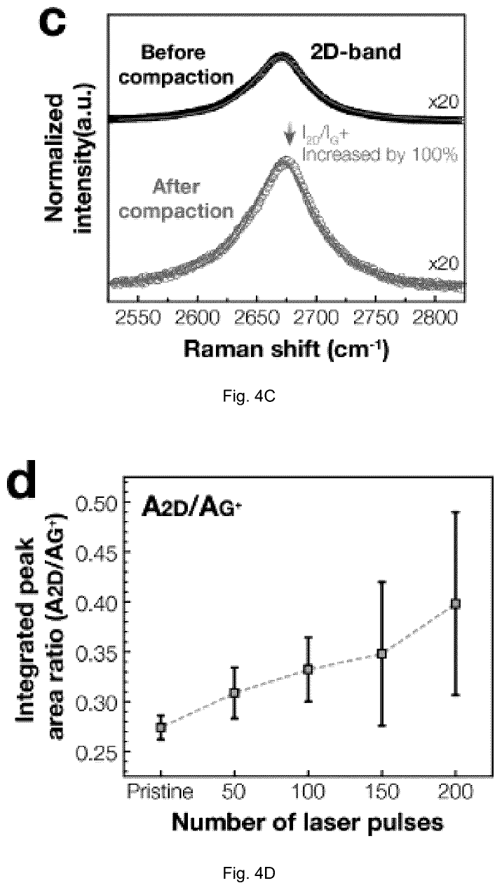

To further investigate the mechanism of structural transformation from SWCNTs to MLG, non-destructive resonant Raman spectroscopy measurements were performed on the SWCNTs film before and after laser shock compaction. Four representative Raman features are examined in FIGS. 3A-3D and 4A-4D: the radial breathing modes (RBMs, 100-400 cm⁻¹), the D-band (~1340 cm⁻¹), the G-band (1550-1590 cm⁻¹), and the 2D-band (G′-band, ~2670 cm⁻¹), each representing a unique spectrum as a structural transition from SWCNTs to layered graphene structure.

FIG. 3A shows the changes in the G-band, also known as the tangential mode, of SWCNT networks film before and after structural transformation. The G-band in SWCNTs consists of two components the G⁻ (1550-1575 cm⁻¹) and G⁺ (1585-1600 cm⁻¹) bands. The G⁻ band at the low-frequency region originates from the circumferential vibration of tubes, and the G⁺ band at the high-frequency region corresponds to graphitic peaks along the axial vibration of nanotubes [39-42]. The G⁺ band of pristine SWCNTs before compaction has undergone deconvolution into peaks at 1590, 1595, and 1601 cm⁻¹, corresponding to the E1g, A1g, and E2g vibrational modes, respectively. These three different modes of the G⁺ band upshift to 1592, 1598, and 1607 cm⁻¹ when SWCNTs transformed into MLG (FIG. 3A). This phenomenon can be interpreted as the interaction between each SWCNT wall becomes strong as interlayer interaction in graphite after laser shockwave compaction-induced MLG formation [27,43-47].

To understand the structural evolution process, the peak evolution of the G⁺ band as a function of pulses of laser shock compaction was systematically evaluated in FIG. 3B. The triplet components, E2g, A1g, and E1g, display a very similar response to the number of laser pulses. All three peaks are upshifted to a higher frequency position after 25 pulses of laser compaction. Specifically, the E1g mode shifts from 1591 cm⁻¹ to 1593 cm⁻¹. The A1g mode shifts from 1595 cm⁻¹ to 1599 cm⁻¹, and the E2g mode shifts from 1602 cm⁻¹ to 1609 cm⁻¹. Interestingly, slight downshifts to lower frequency positions were observed as the number of pulses increases. The average peak positions of E1g, A1g, and E2g modes were downshifted to 1592, 1597, and 1606 cm⁻¹ after 200 pulses of laser compaction (FIG. 3B), where dominant layered graphene structure was seen from observations of HRTEM (FIGS. 1E, 2A, and 2B). This phenomenon was attributed to the following reasons. First, the initial upshifting of the G⁺ band at low pulse number results from compaction of SWCNTs, which enhances the tube-to-tube interaction as randomly oriented SWCNTs transforming into highly compacted SWCNTs bundle (FIG. 1D). Second, the subsequent downshifting in frequency of the G⁺ band at a higher pulse number arises from a relaxation of compressive strain [47] between each SWCNTs or graphene domains, where the SWCNTs unzip and transform into MLG. This is further supported by the changes in the intensity ratio of the G⁻/G⁺-band as a function of number of laser pulses (FIG. 3C). The intensity ratios of the G−1- and G−2-bands to G⁺ band increase significantly at the early stage of laser shock compaction (i.e., 25 pulses). The IG−1/IG+ ratio increased from 0.44 to 0.52, and the IG−2/IG+ ratio increased from 0.24 to 0.35, respectively. The IG−/IG+ ratio is directly correlated with the bundling size of SWCNTs [48-50]; it increased as the bundling size increased due to enhanced packing of SWCNTs, thereby inducing an augmented optical signature of plasmon-phonon coupling in metallic bundles [48-50]. Thus, the initial increase in the IG−/IG+ ratio can be attributed to the increased size of SWCNT bundles after laser shockwave compaction. The IG−1/IG+ ratio and the IG−2/IG+ ratio started to decrease after subsequent laser pulses, reaching values of 0.46 and 0.28 after 200 pulses, which are reduced back to values similar to those of pristine SWCNTs before laser compaction. This trend is explained as follows. (a) The initial shockwave compaction with 25 pulses leads to the bundling of SWCNTs, resulting in an increased IG−/IG+ ratio. (b) Subsequent shockwave compactions trigger the unzipping and collapse of tubular structures by crack propagation. (c) The unzipping or cracked lattice relaxes the bundling of SWCNTs until SWCNTs coalesce into graphene, which leads to a decrease in the IG−/IG+ ratio.

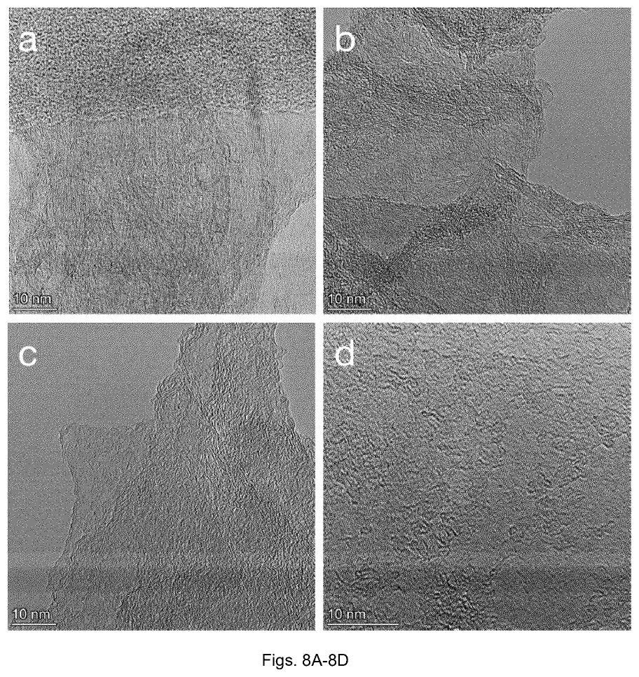

FIG. 3D shows the line-shapes of the D-band of SWCNTs before and after structural transformation. The D-band originates from an edge or discontinuity in the carbon networks [21,39,51-55]. The changes in the intensity ratio of the D-band and frequency have been widely used to evaluate the quality of SWCNT and graphitic materials, as well as to reveal the coalescence process of the SWCNT into graphitic structures [21,54,55]. The ID/IG+ ratio of pristine SWCNTs progressively increases from 0.045 to 0.069 until 150 pules are applied, and it decreases to 0.054 after 200 pulses. These observations suggest a potential structural transformation in response to the continuous unzipping and coalescence of SWCNTs. The ID/IG+ ratio keeps increasing due to unzipping and crack propagation of SWCNTs until 150 pulses of laser shock compaction. It reduces once the coalescence of cracked carbon lattice and unzipped SWCNTs domain into graphene lattice is completed after 200 pulses. The significant variation in the changes of ID/IG+ ratio arises from the presence of multiple structural states of SWCNTs during the laser-induced shockwave compaction, including defective SWCNTs bundles (FIG. 1D), cracked and persistent SWCNT residues (FIGS. 1D and 8A-8D), and unzipped SWCNTs (FIGS. 1D and 8A-8D).

Besides the changes in the D-band and G-band, changes were also expected in other spectra during the structural transition. The changes in the RBM, and 2D-band (G′-band) with the number of laser pulses were explored (FIGS. 4A-4D). For SWCNTs, the RBM (100-400 cm⁻¹) is a unique vibrational mode that originates from the synchronous radial directional movement of carbon atoms, and its frequency is inversely proportional to the diameter of the tube [39,56,57]. The frequency and intensity changes of RBM indicate a direct probe into the compressive strain induced radial dimensional changes in SWCNTs[58-60]. The changes in the prominent RBM peak at 169 cm⁻¹ for pristine SWCNTs were compared as a function of laser pulses (FIGS. 4A-4C). Although the RBM is a unique vibrational mode in SWCNTs, we still can detect the upshifted and intensity-diminished RBM in the transformed MLG structure (FIG. 4A). This originates from the persistent SWCNTs that were not transformed into MLG structures. It was also found that the average frequency of RBM of pristine SWCNTs upshifts continuously from 168.9 to 171.9 cm⁻¹ after 150 and 200 pulses (FIG. 4B). This upshifting of RBM is attributed to the compressive strain applied on persisted SWCNTs due to laser-induced shock compaction. Furthermore, the intensity ratio of the RBM to G⁺ band reduces stepwise from 0.20 to 0.12 after 200 time laser pulses (FIG. 4C). The decrease in the intensity ratio of the RBM to G⁺ band stems from the loss of radial vibration mode as SWCNTs transformed into MLG.

### REFERENCES

1. Javey, Ali, Jing Guo, Qian Wang, Mark Lundstrom, and Hongjie Dai. “Ballistic carbon nanotube field-effect transistors.” Nature 424, no. 6949 (2003): 654-657.
2. Si, Jia, Panpan Zhang, Chenyi Zhao, Dongyi Lin, Lin Xu, Haitao Xu, Lijun Liu, Jianhua Jiang, Lian-Mao Peng, and Zhiyong Zhang. “A carbon-nanotube-based tensor processing unit.” Nature Electronics (2024): 1-10.
3. Liu, Lijun, Jie Han, Lin Xu, Jianshuo Zhou, Chenyi Zhao, Sujuan Ding, Huiwen Shi et al. “Aligned, high-density semiconducting carbon nanotube arrays for high-performance electronics.” Science 368, no. 6493 (2020): 850-856.
4. Peng, Lian-Mao, Zhiyong Zhang, and Chenguang Qiu. “Carbon nanotube digital electronics.” Nature Electronics 2, no. 11 (2019): 499-505.
5. Liu, Jianan, Ruiqing Ding, Jiaming Cao, Ke Zhan, Siquan Li, Bin Zhao, and Vincent Ji. “Recent progress in architecture design of nanocarbon-reinforced metal matrix composites and their properties: A review.” Carbon 228 (2024): 119382.
6. Sun, Xuemei, Hao Sun, Houpu Li, and Huisheng Peng. “Developing polymer composite materials: carbon nanotubes or graphene?.” Advanced Materials 25, no. 37 (2013): 5153-5176.
7. Wu, Zihong, Yan Zhao, Kang Yang, Juan Guan, Shaokai Wang, Yizhuo Gu, Min Li, Yiyu Feng, Wei Feng, and Robert O. Ritchie. “Enhancing the mechanical performance of fiber-reinforced polymer composites using carbon nanotubes as an effective nano-phase reinforcement.” Advanced Materials Interfaces 10, no. 3 (2023): 2201935.
8. Eom, W., Lee, E., Lee, S. H. et al. Carbon nanotube-reduced graphene oxide fiber with high torsional strength from rheological hierarchy control. Nat Commun 12, 396 (2021).
9. Taylor, Lauren W., Oliver S. Dewey, Robert J. Headrick, Natsumi Komatsu, Nicolas Marquez Peraca, Geoff Wehmeyer, Junichiro Kono, and Matteo Pasquali. “Improved properties, increased production, and the path to broad adoption of carbon nanotube fibers.” Carbon 171 (2021): 689-694.
10. Zhang, Xuehuan, Gaoyi Han, and Sheng Zhu. “Flash Nitrogen-Doped Carbon Nanotubes for Energy Storage and Conversion.” Small 20, no. 3 (2024): 2305406.
11. Wang, Yaxiong, Jing Ren, Xiang Gao, Wenjun Zhang, Huiping Duan, Min Wang, Jianglan Shui, and Ming Xu. “Self-Adaptive Electrode with SWCNT Bundles as Elastic Substrate for High-Rate and Long-Cycle-Life Lithium/Sodium Ion Batteries.” Small 14, no. 47 (2018): 1802913.
12. Takakura, Akira, Ko Beppu, Taishi Nishihara, Akihito Fukui, Takahiro Kozeki, Takahiro Namazu, Yuhei Miyauchi, and Kenichiro Itami. “Strength of carbon nanotubes depends on their chemical structures.” Nature Communications 10, no. 1 (2019): 3040.
13. Yu, Choongho, Li Shi, Zhen Yao, Deyu Li, and Arunava Majumdar. “Thermal conductance and thermopower of an individual single-wall carbon nanotube.” Nano Letters 5, no. 9 (2005): 1842-1846.
14. Ruoff, Rodney S., and Donald C. Lorents. “Mechanical and thermal properties of carbon nanotubes.” Carbon 33, no. 7 (1995): 925-930.
15. Dimiev, Ayrat M., Artur Khannanov, Iskander Vakhitov, Airat Kiiamov, Ksenia Shukhina, and James M. Tour. “Revisiting the mechanism of oxidative unzipping of multiwall carbon nanotubes to graphene nanoribbons.” ACS nano 12, no. 4 (2018): 3985-3993.
16. Kosynkin, Dmitry V., Amanda L. Higginbotham, Alexander Sinitskii, Jay R. Lomeda, Ayrat Dimiev, B. Katherine Price, and James M. Tour. “Longitudinal unzipping of carbon nanotubes to form graphene nanoribbons.” Nature 458, no. 7240 (2009): 872-876.
17. Jung, Hyun Young, Paulo T. Araujo, Young Lae Kim, Sung Mi Jung, Xiaoting Jia, Sanghyun Hong, Chi Won Ahn et al. “Sculpting carbon bonds for allotropic transformation through solid-state re-engineering of-sp2 carbon.” Nature Communications 5, no. 1 (2014): 4941.
18. Yu, Fang, Haiqing Zhou, Zengxing Zhang, Gang Wang, Huaichao Yang, Minjiang Chen, Li Tao, Dongsheng Tang, Jun He, and Lianfeng Sun. “Controlled Fabrication of Intermolecular Junctions of Single-Walled Carbon Nanotube/Graphene Nanoribbon.” Small 9, no. 14 (2013): 2405-2409.
19. Dong, Wenjie, Xin Li, Shuai Lu, Jie Li, Yansong Wang, Mingjun Zhong, Xu Dong et al. “Unzipping Carbon Nanotubes to Sub-5-nm Graphene Nanoribbons on Cu (111) by Surface Catalysis.” Small 20, no. 21 (2024): 2308430.
20. Matsumoto, Naoyuki, Azusa Oshima, Guohai Chen, Masako Yudasaka, Motoo Yumura, Kenji Hata, and Don N. Futaba. “Elucidating the effect of heating induced structural change on electrical and thermal property improvement of single wall carbon nanotube.” Carbon 87 (2015): 239-245.
21. Kim, Un Jeong, Humberto R. Gutierrez, Awnish K. Gupta, and Peter C. Eklund. “Raman scattering study of the thermal conversion of bundled carbon nanotubes into graphitic nanoribbons.” Carbon 46, no. 5 (2008): 729-740.
22. Lee, Dongju, Seo Gyun Kim, Seungki Hong, Cristina Madrona, Yuna Oh, Min Park, Natsumi Komatsu et al. “Ultrahigh strength, modulus, and conductivity of graphitic fibers by macromolecular coalescence.” Science Advances 8, no. 16 (2022): eabn0939
23. Yang, Keqin, Jian He, Zhe Su, Jason B. Reppert, Malcolm J. Skove, Terry M. Tritt, and Apparao M. Rao. “Inter-tube bonding, graphene formation and anisotropic transport properties in spark plasma sintered multi-wall carbon nanotube arrays.” Carbon 48, no. 3 (2010): 756-762.
24. Li, Jixue, and Florian Banhart. “The engineering of hot carbon nanotubes with a focused electron beam.” Nano Letters 4, no. 6 (2004): 1143-1146.
25. Banhart, Florian, Jixue Li, and Mauricio Terrones. “Cutting Single-Walled Carbon Nanotubes with an Electron Beam: Evidence for Atom Migration Inside Nanotubes.” Small 1, no. 10 (2005): 953-956.
26. Raghuveer, M. S., P. G. Ganesan, J. D'Arcy-Gall, G. Ramanath, M. Marshall, and I. Petrov. “Nanomachining carbon nanotubes with ion beams.” Applied Physics Letters 84, no. 22 (2004): 4484-4486.
27. Ha, Jeonghong, Jihun Noh, Yung Joon Jung, Wentao Liang, Tae-Y. Choi, Jaehee Kim, and Dongsik Kim. “High compaction and physical graphitization of CNT bundles and network via extreme-load compression using laser-induced shockwave.” Carbon 213 (2023): 118219.
28. Shukla, Pratik P., Philip T. Swanson, and Colin J. Page. “Laser shock peening and mechanical shot peening processes applicable for the surface treatment of technical grade ceramics: a review.” Proceedings of the Institution of Mechanical Engineers, Part B: Journal of Engineering Manufacture 228.5 (2014): 639-652.
29. Ozden, Sehmus, Pedro A. S. Autreto, Chandra Sekhar Tiwary, Suman Khatiwada, Leonardo Machado, Douglas S. Galvao, Robert Vajtai, Enrique V. Barrera, and Pulickel M. Ajayan. “Unzipping carbon nanotubes at high impact.” Nano Letters 14, no. 7 (2014): 4131-4137.
30. NanoIntegris Technologies Inc. “Technical Data Sheet of PureTubes.” Accessed Aug. 6, 2024. nanointegris.com/our-products/unsorted-purified-swnts-superpuretubes-and-puretubes/
31. Kharissova, Oxana V., and Boris I. Kharisov. “Variations of interlayer spacing in carbon nanotubes.” RSC Advances 4, no. 58 (2014): 30807-30815.
32. Zhu, Daming, Hui Gao, Xingmin Zhang, Tieying Yang, Li Li, Guangzhi Yin, Xiuhong Li et al. “Real-time observation of graphene layer growth: Coupling of the interlayer spacing with thickness.” Carbon 94 (2015): 775-780.
33. Weng, Xiaojun, Joshua A. Robinson, Kathleen Trumbull, Randall Cavalero, Mark A. Fanton, and David Snyder. “Structure of few-layer epitaxial graphene on 6H—SiC (0001) at atomic resolution.” Applied Physics Letters 97, no. 20 (2010).
34. Zheng, Dingguo, Chunhui Zhu, Zian Li, Zhongwen Li, Jun Li, Shuaishuai Sun, Yongzhao Zhang et al. “Ultrafast lattice and electronic dynamics in single-walled carbon nanotubes.” Nanoscale Advances 2, no. 7 (2020): 2808-2813.
35. Hernandez, Yenny, Valeria Nicolosi, Mustafa Lotya, Fiona M. Blighe, Zhenyu Sun, Sukanta De, Ignatius T. McGovern et al. “High-yield production of graphene by liquid-phase exfoliation of graphite.” Nature Nanotechnology 3, no. 9 (2008): 563-568.
36. Meyer, Jannik C., A. K. Geim, M. I. Katsnelson, K. S. Novoselov, D. Obergfell, S. Roth, C. Girit, and A. Zettl. “On the roughness of single- and bi-layer graphene membranes.” Solid State Communications 143, no. 1-2 (2007): 101-109.
37. Meyer, Jannik C., Andre K. Geim, Mikhail I. Katsnelson, Konstantin S. Novoselov, Tim J. Booth, and Siegmar Roth. “The structure of suspended graphene sheets.” Nature 446, no. 7131 (2007): 60-63.
38. Brzhezinskaya, Maria, Oleg Kononenko, Victor Matveev, Aleksandr Zotov, Igor I. Khodos, Vladimir Levashov, Vladimir Volkov, Sergey I. Bozhko, Sergey V. Chekmazov, and Dmitry Roshchupkin. “Engineering of numerous moiré superlattices in twisted multilayer graphene for twistronics and straintronics applications.” ACS Nano 15, no. 7 (2021): 12358-12366.
39. Park, Yeseul, K. P. S. S. Hembram, Ran Yoo, Byungjin Jang, Wooyoung Lee, Sang-Gil Lee, Jin-Gyu Kim et al. “Reinterpretation of single-wall carbon nanotubes by Raman spectroscopy.” The Journal of Physical Chemistry C 123, no. 22 (2019): 14003-14009.
40. Rao, Apparao M., E. Richter, Shunji Bandow, Bruce Chase, P. C. Eklund, K. A. Williams, S. Fang et al. “Diameter-selective Raman scattering from vibrational modes in carbon nanotubes.” Science 275, no. 5297 (1997): 187-191.
41. Jorio, Ado, M. A. Pimenta, A. G. Souza Filho, Riichiro Saito, G. Dresselhaus, and M. S. Dresselhaus. “Characterizing carbon nanotube samples with resonance Raman scattering.” New Journal of Physics 5, no. 1 (2003): 139.
42. Stubrov, Yurii, Andrii Nikolenko, Viktor Gubanov, and Viktor Strelchuk. “Manifestation of structure of electron bands in double-resonant raman spectra of single-walled carbon nanotubes.” Nanoscale Research Letters 11 (2016): 1-5.
43. Peters, M. J., Laurie E. Mcneil, Jian Ping Lu, and Daniel Kahn. “Structural phase transition in carbon nanotube bundles under pressure.” Physical Review B 61, no. 9 (2000): 5939.
44. Venkateswaran, U. D., A. M. Rao, E. Richter, M. Menon, A. Rinzler, R. E. Smalley, and P. C. Eklund. “Probing the single-wall carbon nanotube bundle: Raman scattering under high pressure.” Physical Review B 59, no. 16 (1999): 10928.
45. Thomsen, C., S. Reich, H. Jantoljak, I. Loa, K. Syassen, M. Burghard, G. S. Duesberg, and S. Roth. “Raman spectroscopy on single- and multi-walled nanotubes under high pressure.” Applied Physics A 69 (1999): 309-312.
46. Yang, Xigui, Mingguang Yao, Jing Zhang, Zhen Yao, Shuanglong Chen, Mingrun Du, Haiyan Li et al. “Raman study of graphene nanoribbon analogs confined in single-walled carbon nanotubes and their high-pressure transformations.” Journal of Raman Spectroscopy 48, no. 7 (2017): 951-957.
47. Teredesai, Pallavi V., A. K. Sood, Surinder M. Sharma, S. Karmakar, S. K. Sikka, A. Govindaraj, and C. N. R. Rao. “Pressure effects on single wall carbon nanotube bundles.” Physica Status Solidi (b) 223, no. 2 (2001): 479-487.
48. Jiang, Chaoyang, Kris Kempa, Jialong Zhao, Ulrich Schlecht, Ute Kolb, Thomas Basche, Marko Burghard, and Alf Mews. “Strong enhancement of the Breit-Wigner-Fano Raman line in carbon nanotube bundles caused by plasmon band formation.” Physical Review B 66, no. 16 (2002): 161404.
49. Kempa, K. “Gapless plasmons in carbon nanotubes and their interactions with phonons.” Physical Review B 66, no. 19 (2002): 195406.
50. Yano, Taka-aki, Yasushi Inouye, and Satoshi Kawata. “Nanoscale uniaxial pressure effect of a carbon nanotube bundle on tip-enhanced near-field Raman spectra.” Nano Letters 6, no. 6 (2006): 1269-1273.
51. Katagiri, Gen, Hideyuki Ishida, and Akira Ishitani. “Raman spectra of graphite edge planes.” Carbon 26, no. 4 (1988): 565-571.
52. Ferrari, Andrea C., Jannik C. Meyer, Vittorio Scardaci, Cinzia Casiraghi, Michele Lazzeri, Francesco Mauri, Stefano Piscanec et al. “Raman spectrum of graphene and graphene layers.” Physical Review Letters 97, no. 18 (2006): 187401.
53. Pimenta, M. A., G. Dresselhaus, Mildred S. Dresselhaus, L. G. Cancado, Ado Jorio, and R. Saito. “Studying disorder in graphite-based systems by Raman spectroscopy.” Physical Chemistry Chemical Physics 9, no. 11 (2007): 1276-1290.
54. Yi, Bo, Ramakrishnan Rajagopalan, Christopher L. Burket, Henry C. Foley, Xiaoming Liu, and Peter C. Eklund. “High temperature rearrangement of disordered nanoporous carbon at the interface with single wall carbon nanotubes.” Carbon 47, no. 10 (2009): 2303-2309.
55. Endo, Morinobu, Yoong Ahm Kim, Takuya Hayashi, Hiroyuki Muramatsu, Mauricio Terrones, Riichiro Saito, Federico Villalpando-Paez, Shin Grace Chou, and Mildred S. Dresselhaus. “Nanotube Coalescence-Inducing Mode: A Novel Vibrational Mode in Carbon Systems.” Small 2, no. 8-9 (2006): 1031-1036.
56. Shen, Yanting, and Dominic Zerulla. “Prediction of the critical point of pressure-induced deformation-related phase transitions in aligned single-walled carbon nanotubes on the basis of extreme-low-frequency-shift Raman spectroscopy.” Physical Review B 95, no. 20 (2017): 205434.
57. Dresselhaus, Mildred S., G. Dresselhaus, R. Saito, and A. Jorio. “Raman spectroscopy of carbon nanotubes.” Physics Reports 409, no. 2 (2005): 47-99.
58. Venkateswaran, U. D., A. M. Rao, E. Richter, M. Menon, A. Rinzler, R. E. Smalley, and P. C. Eklund. “Probing the single-wall carbon nanotube bundle: Raman scattering under high pressure.” Physical Review B 59, no. 16 (1999): 10928.
59. Teredesai, Pallavi V., A. K. Sood, D. V. S. Muthu, Rahul Sen, A. Govindaraj, and C. N. R. Rao. “Pressure-induced reversible transformation in single-wall carbon nanotube bundles studied by Raman spectroscopy.” Chemical Physics Letters 319, no. 3-4 (2000): 296-302.
60. Loa, I. “Raman spectroscopy on carbon nanotubes at high pressure.” Journal of Raman Spectroscopy 34, no. 7-8 (2003): 611-627.
61. Ferrari, Andrea C., Jannik C. Meyer, Vittorio Scardaci, Cinzia Casiraghi, Michele Lazzeri, Francesco Mauri, Stefano Piscanec et al. “Raman spectrum of graphene and graphene layers.” Physical review letters 97, no. 18 (2006): 187401.
62. Malard, Leandro M., Marcos Assungao Pimenta, Gene Dresselhaus, and Mildred Spiewak Dresselhaus. “Raman spectroscopy in graphene.” Physics Reports 473, no. 5-6 (2009): 51-87.
63. Li, Xiao-Li, Wen-Peng Han, Jiang-Bin Wu, Xiao-Fen Qiao, Jun Zhang, and Ping-Heng Tan. “Layer-number dependent optical properties of 2D materials and their application for thickness determination.” Advanced Functional Materials 27, no. 19 (2017): 1604468.
64. Nirmalraj, P. N., Philip E. Lyons, Sukanta De, Jonathan N. Coleman, and John J. Boland. “Electrical connectivity in single-walled carbon nanotube networks.” Nano Letters 9, no. 11 (2009): 3890-3895.
65. Sheng, Jian, Zhen Han, Guodong Jia, Sheng Zhu, Yifan Xu, Xinrui Zhang, Yixi Yao, and Yan Li. “Covalently bonded graphene sheets on carbon nanotubes: direct growth and outstanding properties.” Advanced Functional Materials 33, no. 43 (2023): 2306785.
66. Balandin, Alexander A. “Thermal properties of graphene and nanostructured carbon materials.” Nature Materials 10, no. 8 (2011): 569-581.
67. Yamaguchi, Shingi, Issei Tsunekawa, Natsumi Komatsu, Weilu Gao, Takuma Shiga, Takashi Kodama, Junichiro Kono, and Junichiro Shiomi. “One-directional thermal transport in densely aligned single-wall carbon nanotube films.” Applied Physics Letters 115, no. 22 (2019): 223102.
68. Hu, Dongmei, Wenbin Gong, Jiangtao Di, Da Li, Ru Li, Weibang Lu, Bohong Gu, Baozhong Sun, and Qingwen Li. “Strong graphene-interlayered carbon nanotube films with high thermal conductivity.” Carbon 118 (2017): 659-665.
69. Lyons, Philip E., Sukanta De, Fiona Blighe, Valeria Nicolosi, Luiz Felipe C. Pereira, Mauro S. Ferreira, and Jonathan N. Coleman. “The relationship between network morphology and conductivity in nanotube films.” Journal of Applied Physics 104, no. 4 (2008).
70. Dai, Hongjie, Eric W. Wong, and Charles M. Lieber. “Probing electrical transport in nanomaterials: conductivity of individual carbon nanotubes.” Science 272, no. 5261 (1996): 523-526.
71. Xiong, Ke, Cheng Ma, Jitong Wang, Xiang Ge, Wenming Qiao, and Licheng Ling. “Highly thermal conductive graphene/carbon nanotubes films with controllable thickness as thermal management materials.” Ceramics International 49, no. 6 (2023): 8847-8855.
72. Zhang, Xiao, Michael De Volder, Wenbin Zhou, Liron Issman, Xiaojun Wei, Adarsh Kaniyoor, Jeronimo Terrones Portas et al. “Simultaneously enhanced tenacity, rupture work, and thermal conductivity of carbon nanotube fibers by raising effective tube portion.” Science Advances 8, no. 50 (2022): eabq3515.
73. Qiu, Lin, Hanying Zou, Xiaotian Wang, Yanhui Feng, Xinxin Zhang, Jingna Zhao, Xiaohua Zhang, and Qingwen Li. “Enhancing the interfacial interaction of carbon nanotubes fibers by Au nanoparticles with improved performance of the electrical and thermal conductivity.” Carbon 141 (2019): 497-505.
74. Noh, Jihun, Qingshun Bai, Rongqi Shen, and Dongsik Kim. “Laser-induced shock wave sintering of silver nanoparticles on flexible substrates.” Applied Surface Science 546 (2021): 149097.
75. R. Fabbro, J. Fournier, P. Ballard, D. Devaux, J. Virmont, Physical study of laser-produced plasma in confined geometry. J. Appl. Phys. 68, 775-784 (1990).
76. Z. Xu, M. J. Buehler, Nanoengineering heat transfer performance at carbon nanotube interfaces. ACS Nano 3, 2767-2775 (2009).
77. E. Ziade, Wide bandwidth frequency-domain thermoreflectance: Volumetric heat capacity, anisotropic thermal conductivity, and thickness measurements, Rev. Sci. Instrum. 91 (2020) 124901. doi.org/10.1063/5.0021917.
78. E. A. Scott, C. Perez, C. Saltonstall, D. P. Adams, V. Carter Hodges, M. Asheghi, K. E. Goodson, P. E. Hopkins, D. Leonhardt, E. Ziade, Simultaneous thickness and thermal conductivity measurements of thinned silicon from 100 nm to 17 μm, Appl. Phys. Lett. 118 (2021) 202108. doi.org/10.1063/5.0050888.
79. B. Treweek, V. Akcelik, W. Hodges, A. Jarzembski, M. Bahr, M. Jordan, A. McDonald, L. Yates, T. Walsh, G. Pickrell, Inversion for Thermal Properties with Frequency Domain Thermoreflectance, ACS Appl. Mater. Interfaces 16 (2024) 4117-4125. doi.org/10.1021/acsami.3c13658.
80. A. Jarzembski, Z. T. Piontkowski, W. Hodges, M. Bahr, A. McDonald, W. Delmas, G. W. Pickrell, L. Yates, Rapid subsurface analysis of frequency-domain thermoreflectance images with K-means clustering, J. Appl. Phys. 135 (2024) 165102. doi.org/10.1063/5.0201473.
81. D. J. Kirsch, J. Martin, R. Warzoha, M. McLean, D. Windover, I. Takeuchi, An instrumentation guide to measuring thermal conductivity using frequency domain thermoreflectance (FDTR), Rev. Sci. Instrum. 95 (2024) 103006. doi.org/10.1063/5.0213738.
82. Y. Gao, A. M. Marconnet, R. Xiang, S. Maruyama, K. E. Goodson, Heat Capacity, Thermal Conductivity, and Interface Resistance Extraction for Single-Walled Carbon Nanotube Films Using Frequency-Domain Thermoreflectance, IEEE Trans. Compon. Packag. Manuf. Technol. 3 (2013) 1524-1532. doi.org/10.1109/TCPMT.2013.2254175.

1. A method of preparing a graphene structure, the method comprising the steps of
(a) providing a film deposited on a substrate, wherein the film comprises or consists of a plurality of single-walled carbon nanotubes (SWCNTs), wherein the film is covered with an ablative layer, and wherein the ablative layer is covered with a transparent shockwave reflective layer; and
(b) irradiating the ablative layer with a series of laser light pulses, whereby each pulse produces shockwave compaction of the SWCNTs and at least a portion of the SWCNTs is converted into the graphene structure.

2. The method of claim 1, wherein step (b) comprises:
(b1) formation of defects in the SWCNTs;
(b2) unzipping of the SWCNTs to form open-edged graphene ribbons; and
(b3) transformation of the open-edged graphene ribbons into said graphene structures.

3. The method of claim 1, wherein the graphene structures are at least in part multilayered, the multilayered graphene structures having an interlayer spacing of about 3.5 nm and from 2 to about 20 graphene layers.

4. The method of claim 1, wherein a plurality of different graphene structures are produced, and the plurality of different graphene structures comprise hybrid nanotube-graphene structures.

5. (canceled)

6. The method of claim 1, wherein step (b) comprises using from about 50 to about 200 laser pulses with a power of about 1.13 GW/cm² per pulse, and wherein the laser light has a wavelength of 1064 nm.

7. The method of claim 1, wherein the film provided in (a) is patterned, and optionally wherein the substrate is patterned.

8. The method of claim 1, wherein the ablative film comprises a metal selected from the group consisting of aluminum, copper, and nickel.

9. (canceled)

10. The method of claim 1, wherein the transparent shockwave reflection layer comprises a material selected from the group consisting of borosilicate glass, optical glass, quartz, and a transparent polymer material.

11. The method of claim 1, wherein the substrate comprises a material selected from the group consisting of alumina, copper, a polymer material, a ceramic material, silicon, and silicon dioxide.

12. The method of claim 1, wherein electrical conductivity of the SWCNTs is increased at least about 2-fold.

13. The method of claim 1, wherein thermal conductivity of the SWCNTs is increased at least about 5-fold.

14. The method of claim 1, wherein step (b) comprises scanning the laser across the film.

15. The method of claim 1, further comprising, prior to step (a) and wherein the substrate is patterned, depositing the SWCNT film onto the patterned substrate whereby the SWCNT film is patterned.

16. The method of claim 1, further comprising patterning the substrate.

17.-18. (canceled)

19. The method of claim 1, wherein the graphene structure is essentially devoid of SWCNT structure.

20. The method of claim 1, wherein the graphene structure forms a junction between two or more separate SWCNT networks.

21. The method of claim 20, wherein the graphene structure comprises covalently continuous graphene-SWCNT hybrid structures.

22. A graphene structure produced by the method of claim 1.

23.-24. (canceled)

25. An electrically or thermally conductive pathway, circuit, or coating comprising one or more covalently continuous graphene-SWCNT hybrid structures.

26.-28. (canceled)

29. A device for preparing a graphene structure from SWCNT by laser shockwave compaction, the device comprising:
a substrate comprising a film deposited on an upper surface of the substrate, wherein the film comprises a plurality of SWCNT;
an ablative layer disposed over the film;
a transparent shockwave reflective layer disposed over the ablative layer; and
a laser configured to apply a series of light pulses through the transparent shockwave reflective layer and onto the ablation layer.

30.-31. (canceled)
